(19) United States
(12) Patent Application Publication
(10) Pub. No.: US 2026/0026429 A1
(43) Pub. Date: Jan. 29, 2026

(54) UTILITY VEHICLE WITH BATTERY MANAGEMENT AND AUTONOMOUS CONTROL SYSTEMS

(71) Applicant: Hydro-Gear Limited Partnership, Sullivan, IL (US)

(72) Inventors: Ivan Viti, Oak Park, IL (US); Eric S. Phanco, Plainfield, IN (US); K. Mike McCoy, Avon, IN (US); Damon J. Hoyda, McCordsville, IN (US)

(21) Appl. No.: 18/993,967

(22) PCT Filed: Jul. 13, 2023
(86) PCT No.: PCT/US2023/070137

§ 371 Date: Jan. 13, 2025

Related U.S. Application Data
(60) Provisional application No. 63/368,330, filed on Jul. 13, 2022.

(51) Int. Cl. A01D 34/00; A01D 34/66; A01D 34/78; A01D 101/00; G05D 1/246; G05D 1/248; G05D 1/644; G05D 1/85; G05D 105/15; G05D 107/20; G05D 111/10; G05D 111/20; G05D 111/30; G07C 5/04; G07C 5/06

(52) U.S. Cl. CPC A01D 34/008; A01D 34/66; A01D 34/78; G05D 1/2462; G05D 1/248; G05D 1/85; G07C 5/04; G07C 5/06; A01D 2101/00; G05D 1/644; G05D 2105/15; G05D 2107/23; G05D 2111/17; G05D 2111/20; G05D 2111/30

(57) ABSTRACT

Utility vehicles with battery management and autonomous control systems are disclosed. A utility vehicle includes driven wheels, electric motor(s), blade motor(s), at least one battery, battery management system(s), global navigation satellite system receiver(s), and controller(s) communicatively connected to memory. The controller(s) identify whether map data for a mow area is stored in the memory and perform a sparse-mow routine in response to identifying no map data in the memory. To perform the sparse-mow routine, the controller(s) autonomously steer the electric utility vehicle to travel over a sample of each portion of the mow area, collect location data, and collect current discharge data. The controller(s) generate an energy-consumption map for the mow area by correlating the current discharge data with the location data and determine an efficient-mow path for subsequent mowing events of the mow area based on the energy-consumption map.

### CROSS-REFERENCE TO RELATED APPLICATION

This application claims the benefit of U.S. Provisional Patent App. No. 63/368,330, filed on Jul. 13, 2022. This prior application is incorporated by reference herein in its entirety.

### TECHNICAL FIELD

This disclosure generally relates to utility vehicles and, more particularly, to utility vehicles with battery management and autonomous control systems.

### BACKGROUND

Utility vehicles exist in a wide variety of forms and types with lawnmowers being among the most popular. Traditionally, the prime mover for a lawnmower consists of an internal combustion engine. The rotary output from the internal combustion engine is then coupled to a belt and pulley combination and/or a direct shaft link, for turning one or more drive systems.

Recently, electric motors have been implemented for use with utility vehicles including lawnmowers. The electric motor is typically powered by a rechargeable battery that is housed on the corresponding lawnmower. In such instances, the lawnmower may operate until the rechargeable battery is low on charge, at which point the lawnmower may be returned to a docking station for recharging.

Also recently, some utility vehicles have implemented autonomous and/or semi-autonomous control features that execute an obstacle-avoidance maneuver when an object being approached is detected. For instance, a typical autonomous lawnmower may include a navigation system for travelling about, and staying within the bounds of, a user's lawn. Some autonomous lawnmowers are able to sense a boundary wire that emits an electromagnetic field or pulse to identify the bounds of the user's lawn and/or other permanently fixed obstacles. Some autonomous lawnmowers include a vision-based navigation system that may detect the presence of an object being approached.

### BRIEF DESCRIPTION OF THE DRAWINGS

FIG. 1 is a schematic view of an example electric vehicle incorporating battery management and autonomous control systems in accordance with the teachings herein.

FIG. 2 is a schematic view of another example electric vehicle incorporating battery management and autonomous control systems in accordance with the teachings herein.

FIG. 3 is a flowchart depicting a subroutine for planning a mow route for a single utility vehicle in accordance with the teachings herein.

FIG. 4 is a flowchart depicting a subroutine for planning mow routes for a fleet of utility vehicles in accordance with the teachings herein.

FIG. 5 is a flowchart depicting a subroutine for collecting data of a utility vehicle while mowing in accordance with the teachings herein.

FIG. 6 is a flowchart depicting a subroutine for alarm or fault detection by a utility vehicle in accordance with the teachings herein.

FIG. 7 is a flowchart depicting a subroutine for adjusting a route or operations of a utility vehicle having a camera for autonomous navigational controls in accordance with the teachings herein.

FIG. 8 is a flowchart depicting a subroutine for adjusting a route or operations of a utility vehicle without a camera for autonomous navigational controls in accordance with the teachings herein.

FIG. 9 is a flowchart depicting a subroutine for extending a battery charge of a utility vehicle in accordance with the teachings herein.

FIG. 10 is a flowchart depicting a subroutine for applying other treatment to a surface area in accordance with the teachings herein.

FIG. 11 depicts an example environment in which the utility vehicle of FIG. 1 and the utility vehicle of FIG. 2 are configured to operate in accordance with the teachings herein.

FIG. 12 depicts an example environment in which a fleet of the utility vehicles of FIG. 1 and/or FIG. 2 operates in accordance with the teachings herein.

### DETAILED DESCRIPTION OF THE DRAWINGS

The description that follows describes, illustrates and exemplifies one or more embodiments of the present invention in accordance with its principles. This description is not provided to limit the invention to the embodiments described herein, but rather to explain and teach the principles of the invention in order to enable one of ordinary skill in the art to understand these principles and, with that understanding, be able to apply them to practice not only the embodiments described herein, but also other embodiments that may come to mind in accordance with these principles. The present specification is intended to be taken as a whole and interpreted in accordance with the principles of the present invention as taught herein and understood by one of ordinary skill in the art.

The scope of the present invention is intended to cover all such embodiments that may fall within the scope of the appended claims, either literally or under the doctrine of equivalents. The specification describes exemplary embodiments which are not intended to limit the claims or the claimed inventions. Features described in the specification, but not recited in the claims, are not intended to limit the claims.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose.

Some features may be described using relative terms such as top, bottom, vertical, rightward, leftward, etc. It should be appreciated that such relative terms are only for reference with respect to the appended drawings. These relative terms are not meant to limit the disclosed embodiments.

An example autonomous and/or semi-autonomous utility vehicle having a drive-and-control system is disclosed herein. The system includes an electric drive system and one or more rechargeable batteries. A smart battery system monitors battery characteristics, such as voltage, current, capacity, temperature, etc. of the batteries. The system also includes other sensors to monitor other characteristics of the utility vehicle and/or a surrounding environment. The system determines a remaining battery power, remaining run time, and/or other calculations based on the collected data and autonomously adjusts operational controls to improve efficiency and/or effectiveness of the utility vehicle.

In some examples, the utility vehicle is a lawnmower configured to mow a designated area. The drive-and-control system includes a controller configured to map an efficient mow route for the lawnmower within the area at least partially based on data of the designated area and data of available power from the batteries. If characteristics of the mow area are unknown, the controller initially sends the lawnmower on an autonomous, sparse-mow routine during which the lawnmower sparsely covers area while collecting mow area and/or power consumption data.

Additionally, when the battery capacity and characteristics of the mow area are known, the drive-and-control system of the lawnmower is configured to perform one or more other functions to optimize performance and/or efficiency of the lawn mower. For example, the controller of the lawnmower is configured to plan and/or adjust the mow route to ensure that the lawnmower is near a charging station when the battery capacity is low. For larger mow areas, the controller is configured to plan and/or adjust the mow route to only cover a portion of the mow area (e.g., the front yard, but not the back yard) in response to determining the battery capacity is unable to power the lawnmower for the entire mow area in a single run.

The system may also include a controller that is configured to adjust operational parameters such as travel speed and/or deck speed to increase the amount of surface area covered by the lawnmower, For example, to conserve energy, the controller may cause the lawnmower to slow down to reduce power draw, speed up to complete mowing in less time, and/or reduce acceleration and deceleration. Further, the system may adjust operation of the lawnmower (e.g., by reducing travel speed or blade power) when one or more batteries are detected as being above a predefined temperature threshold in order to extend the battery life by temporarily reducing battery demand.

In some examples, the drive-and-control system of the lawnmower is configured to monitor power usage relative to locations within the area to be mowed. The location-based power monitoring is performed to improve an estimate of total runtime to mow the area (e.g., instead of relying on averages) and/or adjust the speed and/or cut in high power-consumption areas (e.g., hills, thick grass, etc.). Additionally or alternatively, the location-based power monitoring is performed to maintain straight and parallel mow lines and/or otherwise improve the cut quality by adjusting the mow route to take less cut and/or more overlap in thick grass.

In some examples, the drive-and-control system of the lawnmower is configured to perform an action upon detecting a fault. The lawnmower may autonomously drive to a predetermined location based on the type of fault detected. For example, the lawnmower is configured to return to a charging station when a state-of-charge is low (e.g., for recharging or battery replacement), drive to a secluded and/or otherwise safe area if a thermal fault is detected, and/or drive to a service garage if a serviceable fault (e.g., an inoperable battery pack, a loss of communication with a battery pack, etc.) is detected.

In some examples, the system is configured to calculate an expected power consumption and measure an actual power consumption of the utility vehicle. In response to determining that the actual power consumption is higher than the expected power consumption, the system is configured to transmit an alert to an operator of a potential cause, such as a flat tire, dull or damaged mowing blades, a short circuit, etc. An accuracy of the expected power consumption may be increased by collecting an additional sample of data at the beginning of an operation (e.g., a mow operation).

An example fleet of autonomous and/or semi-autonomous utility vehicles each having a drive-and-control system is disclosed herein. The system of each utility vehicle of the fleet includes a wireless communication device to communicate wirelessly with each of the utility vehicles and/or a remote server. A controller of the remote server and/or one or more of the utility vehicles, such as lawnmowers, is configured to optimizing large mowing areas into zones based on states-of-charge of batteries of the utility vehicles. For example, if the mow area includes a combination of a large yard and a small yard, the controller is configured to assign one lawnmower with a greater state-of-charge to the large yard and another lawnmower with a lesser state-of-charge to the small yard. Additionally, if one lawnmower of the fleet runs out of power, the controller is configured to identify and assign one or more other lawnmowers of the fleet to finish the zone assigned to the unpowered lawnmower.

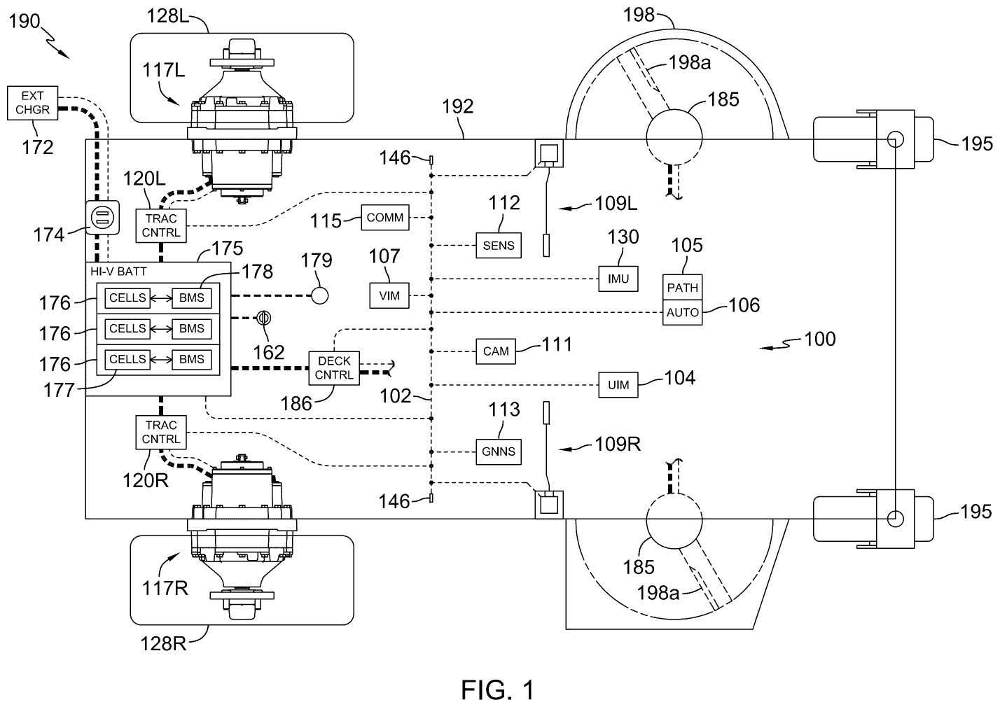

Turning to the figures, FIG. 1 depicts an example utility vehicle 190 with a drive-and-control system 100. In the illustrated example, utility vehicle 190 is a lawnmower. More specifically, in the illustrated example, utility vehicle 190 is a zero turn-radius, riding lawnmower. In other examples, utility vehicle 190 may be another type of lawnmower, such as a non-zero turn-radius lawnmower and/or a stand-on lawnmower. Further, in other examples, utility vehicle 190 may be an unmanned lawnmower. In yet other examples, utility vehicle 190 may be any other type of utility vehicle.

Utility vehicle 190 includes frame 192 and mowing deck 198 mounted to frame 192. Mowing deck 198 includes one or more mowing blades 198a. In the illustrated example, system 100 of utility vehicle 190 includes one more deck motors 185 (also referred to as “blade motors”) to drive mowing blades 198a and one or more deck controllers 186 to control operation of deck motors 185. In illustrated example, system 100 includes one deck controller 186 to control all deck motors 185. In other examples, system 100 includes a respective deck controller 186 for each deck motor 185.

Utility vehicle 190 includes a pair of driven wheels 128 and a pair of caster wheels 195. Driven wheels 128 are positioned toward a rear end of frame 192. In the illustrated example, driven wheels 128 include left driven wheel 128L that is adjacent a rear, left corner and right driven wheel 128R that is adjacent a rear, right corner. Caster wheels 195 are positioned toward a front end of frame 192, with one positioned adjacent a front, left corner and another position adjacent a front, right corner. In other examples, utility vehicle 190 may include more or fewer of driven wheels 128 and/or caster wheels 195. Additionally or alternatively, one or more of driven wheels 128 and/or caster wheels 195 may be positioned differently with respect to frame 192.

Each caster wheel 195 is a non-driven and non-steered wheel that is configured to pivot freely based on how driven wheels 128 are being driven. Each driven wheel 128 is coupled to and configured to be driven by a respective transaxle 117. That is, system 100 of utility vehicle 190 includes left transaxle 117L that is coupled to and configured to drive left driven wheel 128L and includes right transaxle 117R that is coupled to and configured to drive right driven wheel 128R. Each transaxle 117 is coupled to frame 192 and a respective driven wheel 128 to enable transaxle 117 to drive the respective driven wheel 128. Each transaxle 117 is, for example, an electric transaxle. Additionally, each transaxle 117 is communicatively coupled to a respective drive controller 120 (also referred to as a “transaxle controller” and a “traction controller”). That is, system 100 of utility vehicle 190 includes left drive controller 120L that is configured to control operation of left transaxle 117L to control movement of left driven wheel 128L. System 100 of utility vehicle 190 includes right drive controller 120R that is configured to control operation of right transaxle 117R to control movement of right driven wheel 128R.

In the illustrated example, utility vehicle 190 is a fully electric vehicle (also referred to as a “battery electric vehicle”) that includes transaxles 117 for electric drive systems. That is, utility vehicle 190 includes a left drive system for left driven wheel 128L and a right drive system for right driven wheel 128R to provide a zero turn-radius. Left transaxle 117L of left drive system includes an electric motor to drive left driven wheel 128L, and right transaxle 117R of right drive system includes another electric motor to drive right driven wheel 128R. In other examples, utility vehicle 190 includes a single electric motor to drive both driven wheels 128. In some such examples, utility vehicle 190 may be a hybrid vehicle that combines the electric motor with another drive system, such as an internal combustion engine (ICE).

System 100 of utility vehicle 190 includes one or more batteries 176 to power electric devices, such as drive controllers 120, deck controller 186, other controllers, cameras, sensors, etc. In some examples, system 100 of utility vehicle 190 includes a single rechargeable battery 176 (e.g., a Lithium Iron Phosphate (LiFePO₄) battery). In the illustrated, example utility vehicle 190 includes battery system 175 that includes rechargeable and/or swappable batteries 176 (e.g., a Lithium Iron Phosphate (LiFePO₄) battery). Batteries 176 (also referred to as “battery packs”) may be configured to operate in parallel to increase capacity of battery system 175. Each battery 176 includes one or more cells 177 to store energy. In the illustrated example, each battery 176 also includes battery management system (BMS) 178 that is configured to monitor and control operation of respective battery 176. In other examples, battery system 175 may include a single battery management system for all batteries 176. Each battery management system 178 is an electronic module with one or more sensors and circuitry for the monitoring and control of battery 176. As used herein, the terms “module” and “unit” refer to hardware with circuitry to provide monitoring, control, and/or communication capabilities. Battery management system 178 includes sensors and circuitry to monitor and control battery cell temperatures, voltages, charge, discharge currents, etc. Battery management system 178 also is configured to calculate a state-of-health (SOH) for battery 176 based on, for example, an original amp hour capacity, a remaining amp hour capacity, a number of charge and discharge cycles of battery 176, an open circuit voltage of each cell, etc. The state-of-health facilitates an operator in determining when to replace an existing battery with a new one (e.g., when the state-of-health of the current battery is below a predetermined threshold).

In the illustrated example, system 100 of utility vehicle 190 includes key switch 162 and emergency stop button 179 (also referred to as “E-stop”) that are electrically connected to batteries 176 of battery system 175. Key switch 162 is configured to enable a user to turn utility vehicle 190 on and off. Batteries 176 of battery system 175 are configured to deliver power to electrical components of system 100 of utility vehicle 190 when the user turns key switch 162 to an “on” or “start” position. Emergency stop button 179 is configured to turn off utility vehicle 190 and stop batteries 176 from delivering power to the electrical components upon being pressed by the user.

System 100 of utility vehicle 190 also includes charge receptacle 174 that is electrically connected to batteries 176 of battery system 175. Charge receptacle 174 is configured to receive and couple to external charger 172 to recharge batteries 176 in between uses of utility vehicle 190. For example, batteries 176 are configured to be recharged when charge receptacle 174 is securely connected to external charger 172 of charging station 1005 (FIG. J).

In some examples, utility vehicle 190 is a fully autonomous manned or unmanned vehicle. System 100 of utility vehicle 190 includes one or more input devices to monitor operational characteristics of utility vehicle 190 and/or an environment in which utility vehicle 190 is operating. For example, system 100 of utility vehicle 190 includes one or more sensors 112 arranged along an exterior of utility vehicle 190 to collect data indicative of the surrounding environment of utility vehicle 190. In some examples, sensors 112 include one or more radar sensors configured to collect data that detects and locates nearby object(s) via radio waves. In some examples, sensors 112 include one or more ultrasonic sensors configured to collect data that detects and locates nearby object(s) via ultrasonic waves. In the illustrated example, system 100 of utility vehicle 190 includes one or more cameras 111 that are arranged along an exterior of utility vehicle 190 to capture images and/or video of a surrounding area of utility vehicle 190. System 100 of utility vehicle 190 also includes one or more global navigation satellite system (GNSS) receivers 113, such as global positioning system (GPS) receivers, that receive signals from a global positioning system to monitor a location of utility vehicle 190.

System 100 of utility vehicle 190 of illustrated example also includes an inertial measurement unit (IMU) 130 that is securely mounted to frame 192. Inertial measurement unit 130 configured to collect directional, motion, attitude, and/or other data of utility vehicle 190. For example, inertial measurement unit 130 is configured to continuously and in real-time monitor a longitudinal acceleration, a latitudinal acceleration, a yaw rate, a pitch rate, a roll rate, and/or any other characteristics related to movement of utility vehicle 190. In some examples, inertial measurement unit 130 is a multi-axis (e.g., a 3-axis) inertial measurement unit that includes a multi-axis magnetometer, a multi-axis accelerometer, a multi-axis gyroscope, and/or other sensors to collect multi-axis motion data of utility vehicle 190.

System 100 of utility vehicle 190 includes one or more controllers, such as drive controllers 120 and deck controller 186. In the illustrated example, system 100 also includes path controller 105 (also referred to as a “route controller”), autonomous controller 106, and vehicle controller 107 (also referred to as a “vehicle integration module”). Each controller includes a processor and memory. The processor may be any suitable processing device, such as a microprocessor. The memory includes non-volatile memory and/or other types of memory such as volatile memory, read-only memory, etc. The memory is computer readable media on which one or more sets of instructions, such as the software for operating the methods of the present disclosure, can be embedded. The instructions may embody one or more of the methods or logic as described herein. The terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and exclude propagating signals.

In the illustrated example, path controller 105 is configured to determine a path that enables utility vehicle 190 to effectively and efficiently treat area. For example, path controller 105 is configured to determine a mow route that enables utility vehicle 190 to effectively and efficiently mow an area. Path controller 105 is configured to determine a mow route for utility vehicle 190 based on data collected from one or more input devices of utility vehicle 190, such as cameras 111, sensors 112, GNSS receiver 113, inertial measurement unit 130, sensors of battery management systems 178, etc. For example, path controller 105 is configured to combine a plurality of different types of data, such as location data (e.g., GNSS data such as GPS data), map information, preferred route methods, battery capacity information, etc., to generate a mow route and/or path for utility vehicle 190. Path controller 105 is configured generate a mow route in the form of a point-to-point path, waypoints, vectors, etc.

Autonomous controller 106 is configured to transmit control signals based on the mow route generated by path controller 105 and other data collected by input devices of utility vehicle 190. For example, autonomous controller 106 is configured to generate a control signal based on a current location of utility vehicle 190, as determined based on data collected by GNSS receiver 113, relative to the mow route generated by path controller 105. When utility vehicle 190 approaches an object, autonomous controller 106 is configured to generate the control signal further based on data collected by cameras 111 and/or sensors 112 to cause utility vehicle 190 to travel around the object. Further, when utility vehicle 190 is traveling along a slope, autonomous controller 106 is configured to generate the control signal further based on data collected by inertial measurement unit 130. In some examples, autonomous controller 106 is configured to send control signals directly to drive controllers 120 via data bus 102. In other examples, autonomous controller 106 is configured to send signals to vehicle controller 107 that mimic input signals of manual control devices, such as lap bars. In turn, vehicle controller 107 is configured to convert those signals into control signals that are then relayed to drive controllers 120 via data bus 102.

Vehicle controller 107 also is configured to monitor and control other operational features of utility vehicle 190. In some examples, vehicle controller 107 is configured to monitor vehicle and safety interlock statuses based on data collected via data bus 102 and to subsequently respond to status changes as needed. Vehicle controller 107 may include one or ports that are configured to receive display devices to enable a user to interface with vehicle controller 107. In some examples, vehicle controller 107 is configured to determine motor speeds and subsequently may use the motor speed data to confirm whether the motors are running to verify safe operation of utility vehicle 190.

Each of path controller 105, autonomous controller 106, and vehicle controller 107 of illustrated example is separate and has dedicated functionality to perform. In other examples, utility vehicle 190 may include more or fewer controllers to perform the functionality disclosed above. For example, one controller, such as vehicle controller 107, may be configured to perform the functionality of path controller 105 and autonomous controller 106 such that it generates a mow route for and autonomously controls movement of utility vehicle 190.

Further, in the illustrated example, utility vehicle 190 is a manned vehicle that is configured for both user control and autonomous control. Utility vehicle 190 includes left lap bar 109L and right lap bar 109R that enable the user to control movement of utility vehicle 190. Additionally or alternatively, utility vehicle 190 may include another manual control device, such as a joystick, to enable the user to control movement of utility vehicle 190. Lap bars 109 are coupled to respective lap bar sensor modules (LBSMs), which are communicatively coupled to data bus 102. Lap bar sensor modules are configured to send signals to vehicle controller 107, which subsequently convert those signals into control signals that are then relayed to drive controllers 120. In such examples, when autonomous controller 106 transmits signals for the autonomous control of utility vehicle 190, autonomous controller 106 is to send signals to vehicle controller 107 that mimic the signals of the lap bar sensor modules.

Utility vehicle 190 of the illustrated example also includes user interface module (UIM) 104 that includes a display screen, a touchscreen, and/or other user interface(s) for receiving input from and/or displaying information to the user. For example, user interface module 104 is configured to display a remaining charge level of batteries 176 (e.g., as a percentage relative to a full charge) and/or a percentage of a mow area that has yet to be mowed during the current mow routine. Additionally or alternatively, user interface module 104 is configured to display vehicle system level or component level status messages that include, for example, an on/off status or engaged/disengaged status, settings, or parameters of a particular component, assembly, or system of utility vehicle 190.

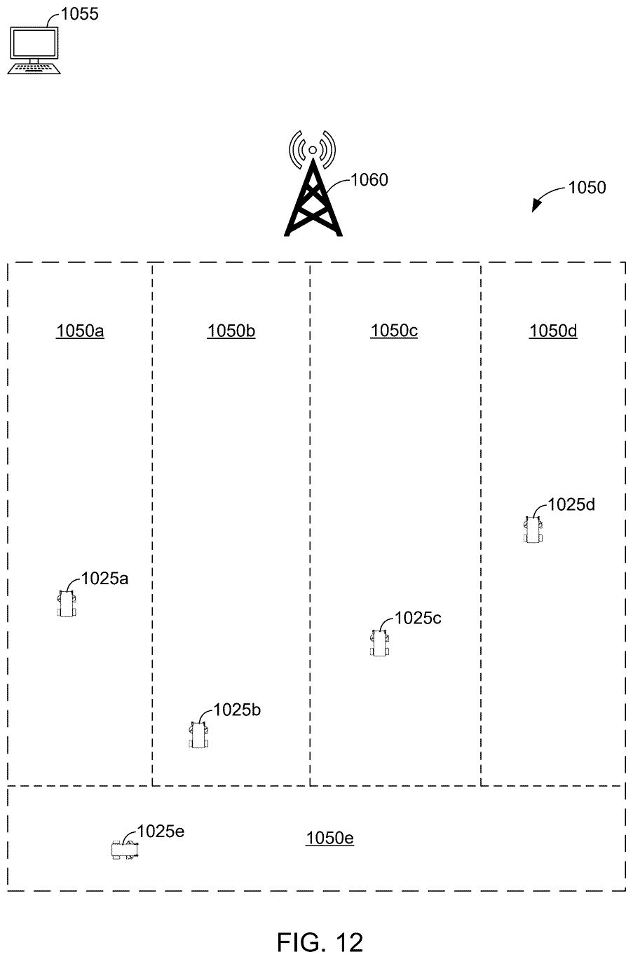

System 100 of utility vehicle 190 also includes a wireless communication module 115 that is configured to communicate wirelessly with one or more external devices. Wireless communication module 115 includes hardware (e.g., processors, memory, storage, antenna, etc.) and software to wirelessly communicate with external devices via cellular networks and/or towers (e.g., cellular tower 1060 of FIG. 12); wireless local area networks, such as Wi-Fi®; wireless personal area networks (WPANs) such as Bluetooth®; low-power wide-area networks, such as long-range wide-area network (LoRaWAN®) and/or other types of communication networks. For example, wireless communication module 115 is configured to communicate with a remote server (e.g., remote server 1055 of FIG. 12), another utility vehicle (e.g., utility vehicles 1025a, 1025b, 1025c, 1025d, 1025e of FIG. 12), and/or a mobile device of the user.

Controllers of system 100 of utility vehicle 190 are communicatively connected to each other and to other electronic components of utility vehicle 190, for example, via wired and/or wireless connections. In illustrated example, system 100 of utility vehicle 190 includes data bus 102 that is configured to communicatively couple the electronic components of utility vehicle 190 together. Data may be posted by any electronic component connected to data bus 102 and received by any other component connected to data bus 102. For example, data bus 102 enables controllers to collect data from one or more sensors and send command signals to one or more controllers. In the illustrated example, each of user interface module 104, path controller 105, autonomous controller 106, vehicle controller 107, cameras 111, sensors 112, GNSS receiver 113, wireless communication module 115, input control module, drive controller 120, inertial measurement unit 130, and deck controller 186 are connected to data bus 102 for posting and receiving distributed data. In other examples, one or more electronic components, such as one or more sensors, may be directly connected to vehicle controller 107 and/or other controller(s) via a wired or wireless connection.

Data bus 102 is, for example, a controller area network (CAN) bus that is implemented in accordance with a CAN bus communication protocol as defined by the 11898 standards of the International Standards Organization (ISO). Data bus 102 may include a wiring harness along which data is transmitted, a plurality of connection interfaces, and a set of termination modules. A connection interface, such as a CAN-Bus T-connection, is connected to the harness and is configured to connect to an electronic device and communicatively connect the electronic device to data bus 102. That is, each electronic device is connected to data bus 102 via a respective connection interface. A termination module 146, such as a CAN-Bus termination module (CTRM), is connected to a respective end of the harness to ensure communication speed and signal integrity.

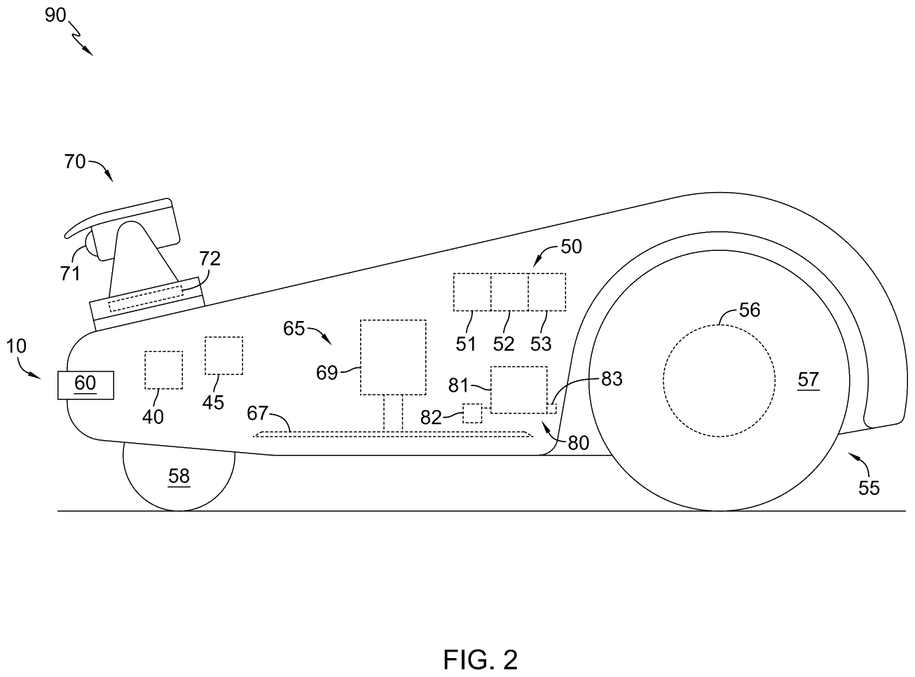

FIG. 2 depicts another example utility vehicle 90 with a drive-and-control system 10. In the illustrated example, utility vehicle 90 is a lawnmower. In other examples, utility vehicle 90 may be another type of utility vehicle.

Utility vehicle 90 includes blade assembly 65. In the illustrated example, blade assembly 65 includes one or more mowing blades 67, one or more blade motors 69, and blade controller 53. Blade motor(s) 69 are configured to drive mowing blade(s) 67, and blade controller 53 is configured to control operation of blade motor(s) 69.

Utility vehicle 90 includes drive assembly 55. In the illustrated example, drive assembly 55 includes driven wheels 57 and one or more caster wheels 58. Driven wheels 57 are positioned toward a rear end of utility vehicle 90, and caster wheel(s) 58 are positioned toward a front end of utility vehicle 90. In other examples, utility vehicle 90 may include more or fewer of driven wheels 57 and/or caster wheels 58. Additionally or alternatively, one or more of driven wheels 57 and/or caster wheels 58 may be positioned differently with respect to a frame of utility vehicle 90.

Drive assembly 55 also includes one or more electric motors 56 and one or more drive controllers 52. In some examples, each driven wheel 57 is operatively coupled to and configured to be driven by a respective electric motor 56. In other examples, drive assembly 55 includes a single electric motor to drive all driven wheels 57. Further, in some examples, each electric motor 56 is communicatively coupled to a respective drive controller 52 such that each drive controller 52 is configured to control operation of a respective electric motor 56. In other examples, each electric motor 56 is communicatively coupled to a shared drive controller 52 such that one drive controller 52 is configured to control operation of all electric motor(s) 56. Each caster wheel 58 is a non-driven and non-steered wheel that is configured to pivot freely based on how driven wheels 57 are being driven.

Utility vehicle 90 is a fully electric vehicle (also referred to as a “battery electric vehicle”) that includes battery system 80, which includes one or more batteries 81 (also referred to as “battery packs”) to power electric devices of utility vehicle 90. Each battery 81 includes one or more cells to store energy. One or more batteries 81 may be configured to operate in parallel to increase capacity of battery system 80. In some examples, each battery 81 may be swappable. Additionally or alternatively, each battery 81 is a rechargeable battery (e.g., a Lithium Iron Phosphate (LiFePO₄) battery). In the illustrated example, battery system 80 also includes charge receptacle 82 that is electrically connected to one or more batteries 81. Charge receptacle 82 is configured to receive and couple to an external charger to recharge one or more batteries 81 in between uses of utility vehicle 90. For example, one or more batteries 81 are configured to be recharged when charge receptacle 82 is securely connected to the external charger of charging station 1005 (FIG. J).

Battery system 80 of the illustrated example also includes one or more battery management systems (BMS) 83 that are configured to monitor and control operation of one or more batteries 81. In some examples, battery system 80 includes a respective battery management system 83 for each battery 81. In other examples, battery system 175 includes a single battery management system 83 for all batteries 81. Each battery management system 83 is an electronic module with one or more sensors and circuitry for the monitoring and control of one or more batteries 81. Battery management system 83 includes sensors and circuitry to monitor and control battery cell temperatures, voltages, charge, discharge currents, etc. For example, battery management system 83 includes a current sensor to measure a discharge current for each battery 81 being monitored. Battery management system 83 may also be configured to calculate a state-of-health (SOH) for one or more batteries 81 based on, for example, an original amp hour capacity, a remaining amp hour capacity, a number of charge and discharge cycles of one or more batteries 81, an open circuit voltage of each cell, etc. The state-of-health facilitates an operator in determining when to replace an existing battery with a new one (e.g., when the state-of-health of the current battery is below a predetermined threshold).

Utility vehicle 90 of the illustrated example is a fully-autonomous, unmanned vehicle. In other examples, utility vehicle 90 may be semi-autonomous and/or manned. System 10 of utility vehicle 90 includes one or more input devices to monitor operational characteristics of utility vehicle 90 and/or an environment in which utility vehicle 90 is operating. For example, system 10 of utility vehicle 90 includes battery management system 83, vision assembly 70, one or more sensors 60, and one or more global navigation satellite system (GNSS) receivers 40 (e.g., global positioning system (GPS) receivers).

System 10 of utility vehicle 90 also includes vision assembly 70 to detect the presence of objects being approached by utility vehicle 90. In the illustrated example, vision assembly 70 includes one or more cameras 71 and vision controller 72. Vision controller 72 is communicatively connected to camera(s) 71. Camera(s) 71 include a two-dimensional camera, a three-dimensional camera, a 360-degree camera, and/or other camera type(s) capable of capturing image(s) and/or video of an area adjacent to utility vehicle 90.

Vision controller 72 is configured to receive image data from camera(s) 71 and extract relevant information from the collected data. In some examples, vision controller 72 is configured to use image recognition software to detect obstacles and/or other objects being approached by utility vehicle 90. For example, vision controller 72 may use image recognition software to perform segmentation of the image(s) captured by camera(s) 71. To perform image segmentation, vision controller 72 may use edge detection and/or machine learning techniques such as artificial neural networks (e.g., convolutional neural networks). Upon detecting an approaching object, vision controller 72 is configured to send corresponding signal(s) to vehicle controller 51. In other examples, vision controller 72 is configured to relay the data collected by camera(s) 71 to vehicle controller 51, and vehicle controller 51 is configured to subsequently perform image recognition to detect approaching obstacles and/or other objects.

Additionally or alternatively, vision controller 72 may use Lidar, radar, ultrasonic and/or other sensor(s) to detect and/or other objects being approached. For example, vision assembly 70 and/or sensor(s) 60 include Lidar sensor(s), radar sensor(s), ultrasonic sensor(s), and/or other sensor(s) for object detection. For example, sensor(s) 60 may include one or more radar sensors configured to collect data that detects and locates nearby object(s) via radio waves. Sensor(s) 60 may include one or more ultrasonic sensors configured to collect data that detects and locates nearby object(s) via ultrasonic waves. One or more of sensor(s) 60 may be arranged along an exterior of utility vehicle 90 to collect data indicative of the surrounding environment of utility vehicle 90.

In response to identifying that an object is being approached by utility vehicle 90, vehicle controller 51 is configured to generate one or more signals for drive controller(s) 52 and/or blade controller(s) 53 to adjust operation of utility vehicle 90. For example, vehicle controller 51 is configured to instruct drive controller(s) 52 to decelerate, stop, turn, and/or employ any combination of maneuvers to avoid the object(s). Vehicle controller 51 is configured to instruct blade controller(s) 53 to adjust (e.g., stop) rotation of mowing blade(s) 67 as the object(s) are being approached.

System 10 of utility vehicle 90 includes one or more controllers 50. Each controller includes a processor and memory. The processor may be any suitable processing device, such as a microprocessor. The memory includes non-volatile memory and/or other types of memory such as volatile memory, read-only memory, etc. The memory is computer readable media on which one or more sets of instructions, such as the software for operating the methods of the present disclosure, can be embedded. The instructions may embody one or more of the methods or logic as described herein.

In the illustrated example, controller(s) 50 include vehicle controller 51, drive controller(s) 52, blade controller(s) 53, and vision controller 72. Additionally or alternatively, controller(s) include a path controller, an autonomous controller, and/or other controller(s). For example, the path controller may be configured to determine the path that enables utility vehicle 90 to effectively and efficiently treat area. The autonomous controller may be configured to transmit control signals based on the mow route generated by the path controller and other data collected by input devices of the utility vehicle 90.

In other examples, vehicle controller 51 is configured to determine the mow route of utility vehicle and/or transmit the control signals for the mow route. For example, vehicle controller 51 is configured to determine a mow route that enables utility vehicle 190 to effectively and efficiently mow an area. Vehicle controller 51 is configured to determine a mow route for utility vehicle 90 based on data collected from one or more input devices of utility vehicle 90. Vehicle controller 51 may be configured generate a mow route in the form of a point-to-point path, waypoints, vectors, etc. Additionally, vehicle controller 51 of the illustrated example is configured to transmit control signals to electric motors 56 based on the generated mow route and other data collected by input devices of utility vehicle 90. For example, vehicle controller 51 is configured to generate a control signal based on a current location of utility vehicle 90, as determined based on data collected by GNSS receiver(s) 40, relative to the generated mow route. GNSS receiver(s) 40 are configured to receive signals from a global positioning system to monitor a location of utility vehicle 190.

Additionally or alternatively, vehicle controller 51 is configured to monitor and control other operational features of utility vehicle 90. For example, vehicle controller 51 is configured to monitor vehicle and safety interlock statuses based on collected data and subsequently respond to status changes as needed. Vehicle controller 51 may include one or ports that are configured to receive display devices to enable a user to interface with vehicle controller 51. Vehicle controller 51 may be configured to determine motor speeds and subsequently may use the motor speed data to confirm whether the motors are running to verify safe operation of utility vehicle 90.

In the illustrated example, each controller 50 is separate and has dedicated functionality to perform. In other examples, utility vehicle 90 may include more or fewer controllers to perform the functionality disclosed above. For example, one controller, such as vehicle controller 51, may be configured to perform the functionality of drive controller(s) 52, blade controller(s) 53, and/or vision controller 72.

Controllers 50 are communicatively connected to each other and to other electronic components of utility vehicle 90, for example, via wired and/or wireless connections. For example, system 10 may include a data bus that is configured to communicatively couple the electronic components of utility vehicle 90 together. Data may be posted by any electronic component connected to the data bus and received by any other component connected to the data bus. In other examples, one or more electronic components, such as one or more of sensor(s) 60, may be directly connected to vehicle controller 51 and/or other controller(s) 50 via a wired or wireless connection.

System 10 of utility vehicle 90 also includes a wireless communication module 45 that is configured to communicate wirelessly with one or more external devices. Wireless communication module 45 includes hardware (e.g., processors, memory, storage, antenna, etc.) and software to wirelessly communicate with external devices via cellular networks and/or towers (e.g., cellular tower 1060 of FIG. 12); wireless local area networks, such as Wi-Fi®; wireless personal area networks (WPANs) such as Bluetooth®; low-power wide-area networks, such as long-range wide-area network (LoRaWAN®) and/or other types of communication networks. For example, wireless communication module 45 is configured to communicate with a remote server (e.g., remote server 1055 of FIG. 12), another utility vehicle (e.g., utility vehicles 1025a, 1025b, 1025c, 1025d, 1025e of FIG. 12), and/or a mobile device of the user.

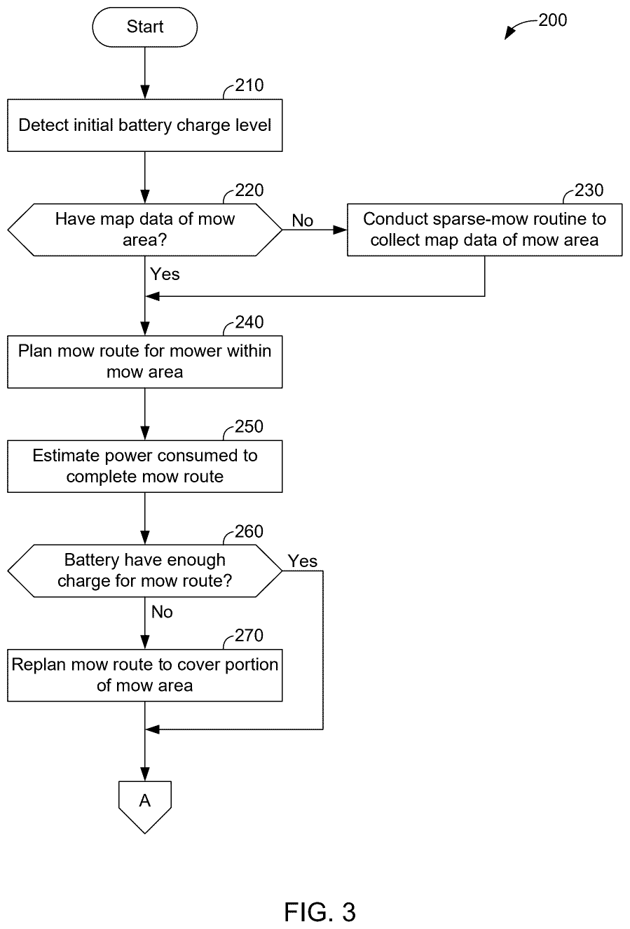

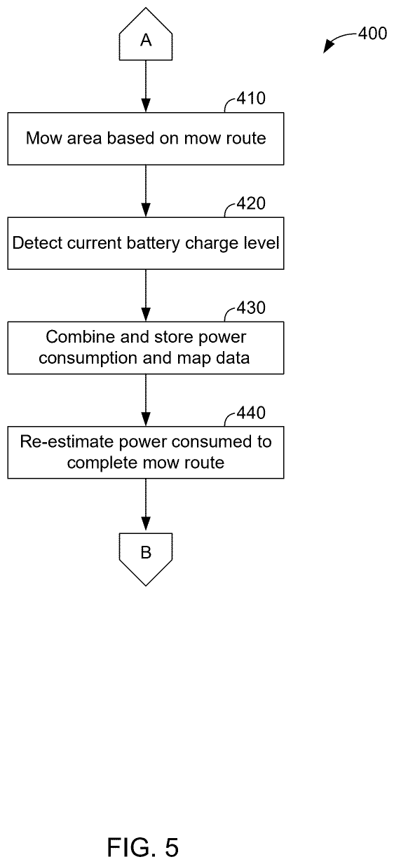

FIGS. 3-10 depict flowcharts of example methods for performing battery management and/or autonomous control operations of utility vehicle 190 and/or a fleet of utility vehicles 190. The flowcharts of FIGS. 3-10 are representative of machine readable instructions that are stored in memory and include one or more programs which, when executed by a processor (such as processor(s) of path controller 105, autonomous controller 106, vehicle controller 107, drive controllers 120, and/or deck controller 186 of FIG. 1 and/or processor(s) of controller(s) 50, vehicle controller 51, drive controller(s) 52, blade controller(s) 53 and/or vision controller 72 of FIG. 2), cause a utility vehicle (e.g., utility vehicle 190 of FIG. 1, utility vehicle 90 of FIG. 2) and/or a fleet of utility vehicles (e.g., utility vehicle(s) 190 of FIG. 1 and/or utility vehicle(s) 90 of FIG. 2) to implement battery management and/or autonomous control operations. While the example programs are described with reference to the flowcharts of FIGS. 3-10, other methods may alternatively be used. For example, the order of execution of the blocks may be rearranged, changed, eliminated, and/or combined to perform the battery management and/or autonomous control operations. Further, because the method is disclosed in connection with the utility vehicle components of FIG. 1 and/or FIG. 2, some functions of those components will not be described in detail below.

FIG. 3 depicts subroutine 200 for planning a mow route for a single utility vehicle 90, 190. Initially, at block 210, one or more controllers (e.g., vehicle controller 51, 107) detect an initial charge level of one or more batteries 81, 176 of battery system 80, 175. In some examples, battery management system(s) 83, 178 detect charge levels of one or more batteries 81, 176 and send the detected charge levels to those controller(s), for example, via data bus 102. In other examples, those controller(s) determine the initial charge level based on other data collected from battery management system(s) 83, 178.

At block 220, one or more controllers (e.g., path controller 105; vehicle controller 51, 107; etc.) determine whether map data has been collected for the selected mow area. For example, map data is stored in memory of utility vehicle 90, 190 and/or a remote server (e.g., remote server 1055 of FIG. 12) in communication with utility vehicle 90, 190. In response to those controller(s) determining that map data has been collected for the mow area, the method proceeds to block 240. Otherwise, in response to those controller(s) determining that map data has yet to be collected for the mow area, the method proceeds to block 230 at which one or more controllers (e.g., autonomous controller 106; vehicle controller 51, 107; etc.) sends control signals (e.g., to drive controller(s) 52, 120) to cause utility vehicle 90, 190 to conduct a sparse-mow routine. Utility vehicle 90, 190 performs a sparse-mow routine to collect data (also referred to as “sparse-mow data”) for the planning of an efficient mow route for the mow area. During a sparse- mow routine, utility vehicle 90, 190 traverses the mow area in sparse paths with each path potentially including considerable overlap of non-mowed grass relative with adjacent paths. The sparse paths enable camera(s) 71, 111; battery management system(s) 83, 178; GNSS receiver(s) 40, 113; sensors 60, 112; and/or other sensors to collect information of the current conditions of the mow area (e.g., grass conditions, existence of hills, etc.) without consuming a large amount of the remaining charge of one or more batteries 81, 176.

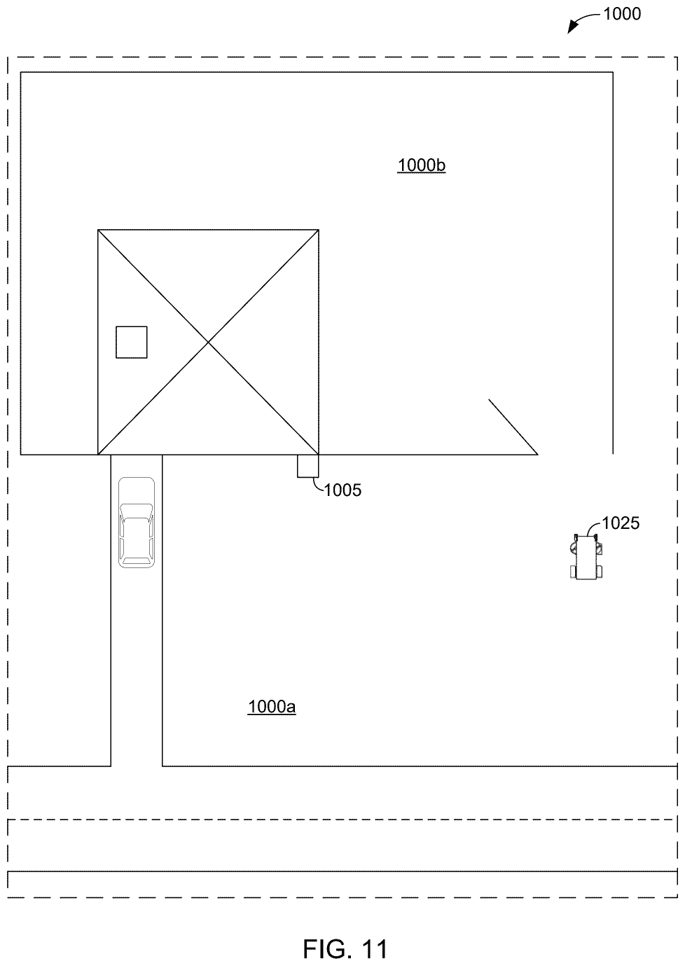

Turning briefly to FIG. 11, utility vehicle 1025 is utility vehicle 90, utility vehicle 190, and/or another utility vehicle capable of cutting mow area 1000 in the manner disclosed herein. Prior to starting a sparse-mow routine for a mow area, an operator may identify a boundary of mow area 1000 for utility vehicle 90, 190 to enable utility vehicle 90, 190 to perform autonomous features. In some examples, a perimeter wire is buried or placed around the perimeter of mow area 1000. In such examples, one or more sensors 60, 112 is configured to detect when utility vehicle 90, 190 is approaching and/or traveling along the boundary of mow area 1000 to retain utility vehicle 90, 190 within mow area 1000 during operation. Additionally or alternatively, utility vehicle 90, 190 may use geo-fencing to identify the boundary of mow area 1000. For example, the boundary of mow area 1000 is associated with corresponding GNSS coordinates (e.g., GPS coordinates). The GNSS coordinates of the boundary of mow area 1000 may be recorded prior to autonomous use as an operator guides (e.g., steers, pushes, etc.) utility vehicle 90, 190 along the boundary of mow area 1000.

If map data for mow area 1000 has yet to be collected after the boundary for mow area 1000 has been set, one or more controllers (e.g., autonomous controller 106; vehicle controller 51, 107; etc.) initiate a sparse-mow routine for utility vehicle 90, 190. Utility vehicle 90, 190 performs a sparse-mow routine to enable the one more controllers and/or another device (e.g., a remote server) to plan an efficient-mow routine for subsequent mowing events for mow area 1000.

During the sparse-mow routine, one or more controllers (e.g., autonomous controller 106; vehicle controller 51, 107; etc.) are configured to generate a sparse-mow path along which utility vehicle 90, 190 is to travel during the sparse-mow routine to efficiently collect data associated with mowing mow area 1000. In some examples, the sparse-mow path causes utility vehicle 90, 190 to travel over only a portion of mow area 1000 to increase the efficiency of the sparse-mow routine. For example, utility vehicle 90, 190 travels over a sample of each portion of mow area 1000 for the sparse-mow routine. In some examples, the sparse-mow path may result in utility vehicle 90, 190 leaving unmowed sections the width of a cut width between passes along the sparse-mow route. In turn, utility vehicle 90, 190 is able to collect data indicative of all sections of mow area while reducing the distance traveled to collect such information (e.g., by about 50%).

In some examples, the sparse-mow path includes a Hamiltonian path or cycle such that each location along the path is visited only once by utility vehicle 90, 190 for efficiency purposes. The Hamiltonian path or cycle may be planned based on predefined boundary lines of mow area 1000. In other examples, one or more controllers (e.g., autonomous controller 106; vehicle controller 51, 107; etc.) are configured to control movement of utility vehicle 90, 190 based on a set of preprogrammed rules. For example, those controller(s) may be configured to steer utility vehicle 90, 190 in a direction that sends it farthest away from a portion of mow area 1000 that has already been examined during the sparse-mow routine. Alternatively, those controller(s) may be configured to (1) steer utility vehicle 90, 190 in a first direction (e.g., north) until the border or an object is detected, (2) subsequently turn utility vehicle 90, 190 to travel in a second direction (e.g., east) until the border or an object is detected, (3) subsequently turn utility vehicle 90, 190 to travel in a third direction (e.g., south) until the border or an object is detected, and (4) subsequently turn utility vehicle 90, 190 to travel in a fourth direction (e.g., west) until the border or an object is detected. The sequence of turning based on the set of preprogrammed rules is repeated until the sparse-mow routine has covered mow area 1000.

In some examples, the sparse-mow path is generated based on a map of mow area 1000 and/or coordinates of boundaries of mow area 1000. One or more controllers (e.g., autonomous controller 106; vehicle controller 51, 107; etc.) are configured to identify that the sparse-mow routine is complete upon detecting that utility vehicle 90, 190 has traveled the length of the sparse-mow path. Additionally or alternatively, those controller(s) are configured to identify that the sparse-mow routine is complete in response to determining that data collected by GNSS receiver(s) 40, 113 indicates that utility vehicle 90, 190 has traveled to all areas of mow area 1000 during the sparse-row routine.

During a sparse-mow routine, battery management system(s) 83, 178; GNSS receiver(s) 40, 113; and/or other sensors 60, 112 of utility vehicle 90, 190 collect information of the current conditions of mow area 1000. For example, for each location along which utility vehicle travels during the sparse-mow routine, the one or more controllers (1) record coordinates of a location as identified by GNSS receiver(s) 40 and 113 and (2) record energy consumed by one or more batteries 81, 176 at that location as identified by battery management system(s) 83, 178. In turn, those controller(s) are configured to identify how much energy is required to mow different locations within mow area 1000 and generate an energy consumption map for mow area 1000 based on the collected data. In some examples, those controller(s) are configured to generate the energy consumption map based on other additional collected data (e.g., historical mow data; weather data collected via wireless communication module 45, 115; wetness data collected via a moisture sensor of utility vehicle 90, 190; cut length data; etc.). The map may identify locations that require less energy consumption to mow (e.g., flat land, thin grass, etc.) and/or locations that require more energy consumption to mow (e.g., hilly land, thick grass, etc.). Additionally, those controller(s) are configured to generate an efficient-mow routine, based on the generated map, that minimizes and/or otherwise reduces an amount of energy that is predicted to be consumed when mowing mow area 1000.

Upon completing block 230, the method proceeds to block 240 at which one or more controllers (e.g., path controller 105; vehicle controller 51, 107; etc.) plan a mow path for utility vehicle 90, 190 that enables utility vehicle 90, 190 to efficiently mow mow area 1000 for the current session and future sessions. At block 250, those controller(s) estimate the charge or power consumed to complete the planned mow route, for example, based on map data for the planned mow path and historical power consumption data of utility vehicle 90, 190.

At block 260, one or more controllers (e.g., vehicle controller 51, 107) determine whether one or more batteries 81, 176 have enough charge to complete the planned mow path. For example, those controller(s) determine whether one or more batteries 81, 176 have enough charge by comparing the initial battery charge level of block 210 to the estimated or predicted charge consumption of block 250. The estimated or predicted charge consumption may be determined based on geographic data of mow area 1000. In some examples, the geographic data is collected by GNSS receiver 40, 113. In response to those controller(s) determining that one or more batteries 81, 176 have enough charge for the planned mow path, subroutine 200 ends and the method of operation proceeds to subroutine 400. Otherwise, in response to those controller(s) determining that one or more batteries 81, 176 do not have enough charge for the planned mow path, the method proceeds to block 270.

At block 270, one or more controller(s) (e.g., path controller 105; vehicle controller 51, 107; etc.) replan the mow route to cover a portion of mow area 1000. That is, prior to mowing mow area 1000, those controller(s) may determine that utility vehicle 90, 190 is unable to complete a total mow area based on current charge levels of one or more batteries 81, 176. In such examples, those controller(s) adjust a planned mow route to cut a portion of the mow area in an aesthetically pleasing manner. Returning briefly to FIG. 11, those controller(s) may change the planned mow route from cutting mow area 1000 in a spiral pattern to only cutting front yard 1000a during the current session to prevent utility vehicle 1025 from stopping in the middle of a spiral pattern in an aesthetically displeasing manner. Those controller(s) may then plan to mow backyard 1000b during another session after one or more batteries 81, 176 of utility vehicle 1025 have been recharged. Returning to FIG. 3, subroutine 200 ends and the method of operation proceeds to subroutine 400 upon completion of block 270.

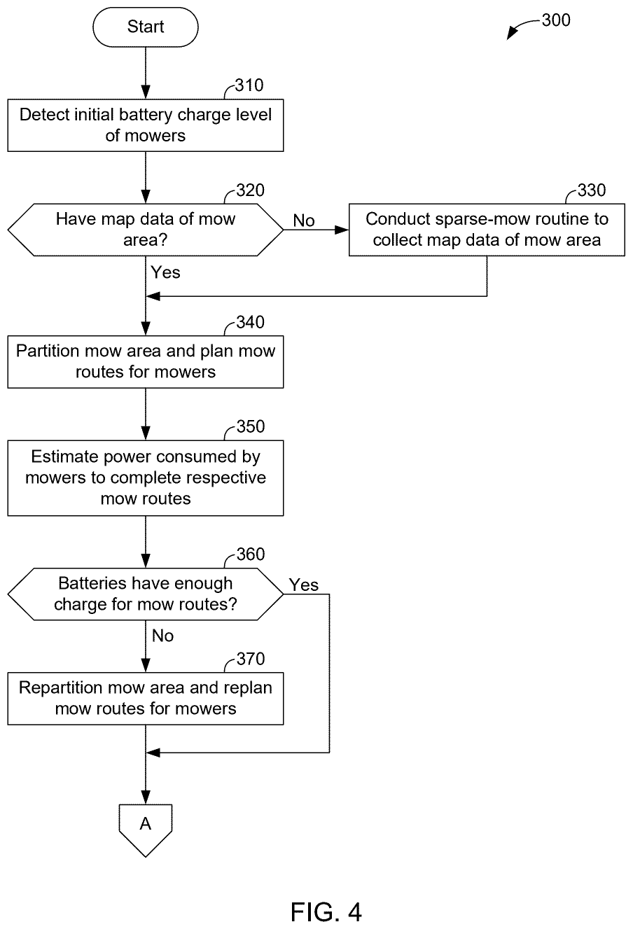

Turning to FIG. 4, subroutine 300 enables a fleet of utility vehicles to cut mow area 1050 in a complete and efficient manner. As illustrated in FIG. 12, a fleet of utility vehicles 1025, including utility vehicles 1025a, 1025b, 1025c, 1025d, 1025e may be used for mow area 1050. Each utility vehicle 1025 is utility vehicle 90, utility vehicle 190, and/or another utility vehicle capable of cutting mow area 1050 in the manner disclosed herein. Each utility vehicle 1025a, 1025b, 1025c, 1025d, 1025e may be assigned a respective portion 1050a, 1050b, 1050c, 1050d, 1050e of mow area 1050. In some examples, as shown in FIG. 12, mow area 1050 is contiguous such that portions 1050a, 1050b, 1050c, 1050d, 1050e border each other. In other examples, mow area 1050 may be non-contiguous. For example, mow area 1050 may include a plurality of lawns that are spaced apart from each other.

In some examples, one or more controllers (e.g., path controller 105 and/or vehicle controller 51, 107) of one utility vehicle 1025 plan mow routes for each utility vehicle 1025, and/or one or more controllers (e.g., vehicle controller 51, 107) of that utility vehicle 1025 monitor charge levels of each utility vehicle 1025. Each utility vehicle 1025 may be capable of planning mow routes for itself and/or other utility vehicles 1025 of the fleet. In such examples, utility vehicles 1025 wirelessly communicate with each other via respective wireless communication modules 45, 115. Utility vehicles 1025 may communicate with each other via cellular communication with cellular tower 1060 and/or directly with each other, for example, via wireless local area networks (e.g., Wi-Fi®) and/or low-power wide-area networks (e.g., LoRaWAN®). In other examples, remote server 1055 includes a controller that monitors charge levels for all utility vehicles 1025. In such examples, the controller of remote server 1055 wirelessly communicates with each utility vehicle 1025 via cellular communication with cellular tower 1060. The controller collects data from each utility vehicle 1025, plans respective mow routes based on the collected data, and sends the mow routes to respective utility vehicles 1025.

Returning to FIG. 4, subroutine 300 plans and/or adjusts mow zones and/or routes assigned to respective utility vehicles 1025 based on a current conditions of respective one or more batteries 81, 176. For example, subroutine 300 is performed to assign smaller mow portions to utility vehicles 1025 with reduced remaining battery capacity.

Initially, at block 310, one or more vehicles (e.g., vehicle controller 51, 107) detect an initial charge level of one or more batteries 81, 176 for each utility vehicle 1025a, 1025b, 1025c, 1025d, 1025e. In some examples, battery management system(s) 83, 178 detect charge levels of one or more batteries 81, 176 and send the detected charge levels to those controller(s). In other examples, those controller(s) determine the initial charge level based on other data collected from battery management system(s) 83, 178.

At block 320, one or more vehicles (e.g., path controller 105; vehicle controller 51, 107; etc.) determine whether map data has been collected for the selected mow area. In response to those controller(s) determining that map data has been collected for the mow area, the method proceeds to block 340. Otherwise, in response to those controller(s) determining that map data has yet to be collected for the mow area, the method proceeds to block 330.

At block 330, one or more controller(s) (e.g., autonomous controller 106; vehicle controller 51, 107; etc.) of one or more utility vehicles 1025a, 1025b, 1025c, 1025d, 1025e cause those utility vehicles 1025a, 1025b, 1025c, 1025d, 1025e to conduct a sparse-mow routine. Upon completing block 330, the method proceeds to block 340.

At block 340, one or more controllers (e.g., path controller 105; vehicle controller 51, 107; a controller of remote server 1055; etc.) partition mow area 1050 into portions 1050a, 1050b, 1050c, 1050d, 1050e and plans a mow path for a respective utility vehicle 1025a, 1025b, 1025c, 1025d, 1025e within each portion 1050a, 1050b, 1050c, 1050d, 1050e. For example, those controller(s) may assign a relatively large portion (e.g., a large yard) to one utility vehicle having a greater charge capacity and assigns a relatively small portion (e.g., a nearby small yard) to another utility vehicle having a lesser charge capacity. At block 350, those controller(s) estimate the charge or power consumed to complete the planned mow routes, for example, based on map data for the planned mow path and historical power consumption data of utility vehicles 1025a, 1025b, 1025c, 1025d, 1025e.

At block 360, one or more controllers (e.g., vehicle controller 51, 107a, controller of remote server 1055; etc.) determine whether one or more batteries 81, 176 of each utility vehicle 1025a, 1025b, 1025c, 1025d, 1025e have enough charge to complete the respective planned mow path. The estimated or predicted charge level may be determined based on geographic data of mow area 1050. In some examples, the geographic data is collected by GNSS receiver 40, 113. In response to those controller(s) determining that batteries 176 of all utility vehicles 1025a, 1025b, 1025c, 1025d, 1025e have enough charge for the respective planned mow paths, subroutine 300 ends and the method of operation proceeds to subroutine 400. Otherwise, in response to those controller(s) determining that batteries 176 one or more utility vehicles 1025a, 1025b, 1025c, 1025d, 1025e do not have enough charge for the respective planned mow path, the method proceeds to block 370.

At block 370, one or more controllers (e.g., path controller 105; vehicle controller 51, 107; a controller of remote server 1055; etc.) repartitions portions 1050a, 1050b, 1050c, 1050d, 1050e of mow area 1050 and replans the mow routes for utility vehicles 1025a, 1025b, 1025c, 1025d, 1025e. For example, those controller(s) adjust and/or reassign one or more portions 1050a, 1050b, 1050c, 1050d, 1050e of mow area 1050 upon determining, based on the battery capacity of one or more utility vehicles 1025a, 1025b, 1025c, 1025d, 1025e, that one or more of utility vehicles 1025a, 1025b, 1025c, 1025d, 1025e are unable to complete their mow path.

In some examples, each utility vehicle 1025 collects charge level data for its batteries 81, 176 and determines whether it is able to complete its mow path. Upon identifying that it is unable to complete its mow path, that utility vehicle 1025 repartitions mow area 1050 and transmits instructions to other utility vehicles 1025 for the repartitioning of mow area 1050.

In some examples, each utility vehicle 1025 collects charge level data for its batteries 81, 176 and sends the collected data to another utility vehicle 1025 (e.g., a primary vehicle) for analysis. In such examples, the primary vehicle determines whether each utility vehicle 1025 is able to complete its mow path. In other examples, each utility vehicle determines whether it is able to complete its mow path and sends a signal to the primary vehicle if it is unable to perform its mow path. Upon identifying that at least one utility vehicle 1025 is unable to complete its mow path, the primary vehicle repartitions mow area 1050 and transmits instructions to the other utility vehicles 1025 for the repartitioning of mow area 1050.

In some examples, each utility vehicle 1025 collects charge level data for its batteries 81, 176 and sends the collected data to remote server 1055 for analysis. In such examples, remote server 1055 determines whether each utility vehicle 1025 is able to complete its mow path. In other examples, each utility vehicle determines whether it is able to complete its mow path and sends a signal to remote server 1055 if it is unable to perform its mow path. Upon identifying that at least one utility vehicle 1025 is unable to complete its mow path, remote server 1055 repartitions mow area 1050 and transmits instructions to the other utility vehicles 1025 for the repartitioning of mow area 1050.

Upon completing block 370, subroutine 300 ends and the method of operation proceeds to subroutine 400.

FIG. 4 depicts subroutine 400 that is performed to collect operational data while utility vehicle 90, 190 is traveling and mowing along its mow route. Initially, at block 410, utility vehicle 90, 190 mows within the mow area based on the mow route planned by one or more controllers (e.g., path controller 105; vehicle controller 51, 107; etc.).

One or more controllers (e.g., autonomous controller 106; vehicle controller 51, 107; etc.) determine control signals at least partially based on the planned mow route. For example, if no objects are detected based on data collected by cameras 111, sensors 112, and/or GNSS receiver 113, those controller(s) generate control signals to autonomously travel along the planned mow route. If an object is detected based on the collected data, those controller(s) generate control signals to autonomously travel around the object and then subsequently return to the planned mow route. Drive controller(s) 52, 120 receive the control signals and control operation of respective driven wheels 57, 128 (e.g., via transaxles 117) to autonomously travel along the desired path.

At block 420, one or more controllers (e.g., vehicle controller 51, 107) identify current charge level(s) of one or more batteries 81, 176 of battery system 80, 175 while utility vehicle 90, 190 is autonomously travelling along the desired path. In some examples, those controller(s) determine the charge levels based on data received from battery management system(s) 83, 178. In other examples, battery management system(s) 83, 178 detect the charge level(s) of respective one or more batteries 81, 176 and send the charge levels to those controller(s) (e.g., via data bus 102).

At block 430, one or more controllers (e.g., vehicle controller 51, 107) of utility vehicle 90, 190 combine and store the collected power consumption data with the map data in memory. In some examples, the data is stored in memory onboard utility vehicle 90, 190. In other examples, the data is stored in memory of a remote device. In such examples, wireless communication modules 45, 115 may wirelessly communicate the data to the remote device, such as remote server 1055, for subsequent storage.

At block 440, one or more controllers (e.g., path controller 105; vehicle controller 51, 107; etc.) re-estimate the power consumed to complete the current mow route. For example, those controller(s) determine the updated power consumption estimation in a manner identical to that of block 250 and using the current battery charge levels detected at block 420.

That is, one or more controllers (e.g., (e.g., path controller 105; vehicle controller 51, 107; etc.) continuously monitor a power consumption rate and re-estimate a remaining battery capacity of one or more batteries 81, 176 for when utility vehicle 90, 190 has completed the mow area. The power consumption rate may vary based on grass conditions (e.g., thickness, height, wetness, etc.) and/or other surface conditions (e.g., the presence of hills). Those controller(s) use the collected and generated information, such as power consumption data, remaining battery capacity data, planned mow route, etc., to more accurately estimate the total time needed to mow the area and return to charging station 1005. Those controller(s) continuously monitor the power consumption rate during each mowing session to account for the estimated the total time varying from session-to-session due to changing environmental conditions.

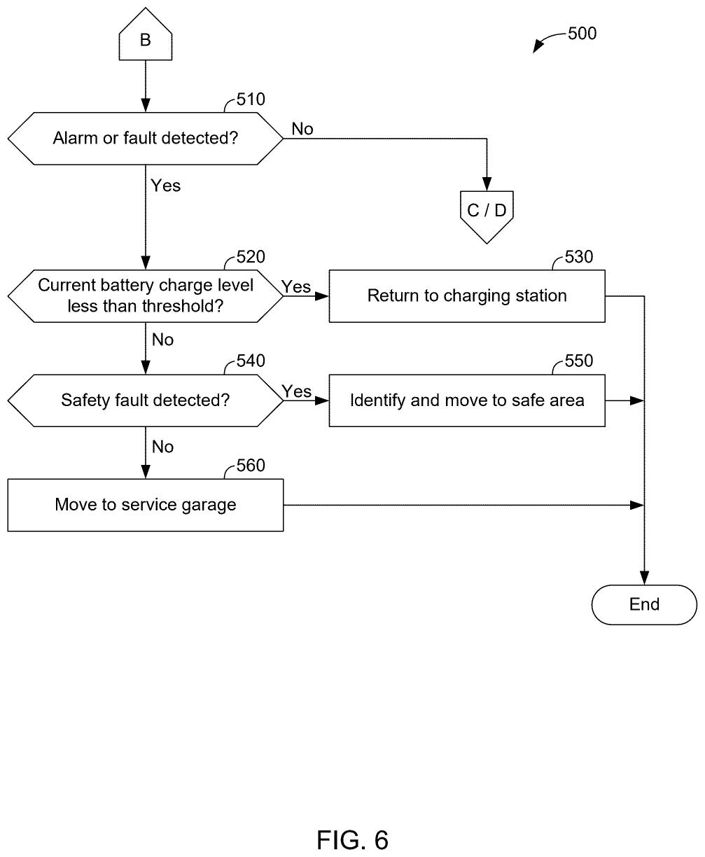

Upon completing subroutine 400, the method of operation proceeds to subroutine 500. As shown in FIG. 6, subroutine 500 is performed to monitor for potential alarms or faults of utility vehicle 90, 190.

Initially, at block 510, one or more controllers (e.g., vehicle controller 51, 107) determine whether an alarm or fault is detected. Additionally, in some examples, those controller(s) send a signal to emit an audio, visual, and/or haptic alert associated with the alarm or fault to an operator of utility vehicle 90, 190. For example, those controller(s) send the alert signal to wireless communication module 45, 115, and wireless communication module 45, 115 relays the alert signal to a remote device (e.g., remote server 1055, a mobile device of the operator, etc.) to remotely inform the operator of the alarm or fault.

In response to those controller(s) detecting the presence of an alarm or fault, the method proceeds to block 520 at which those controller(s) determine whether a current charge level of one or more batteries 81, 176 of battery system 80, 175 is less than a predetermined charge threshold. In some examples, those controller(s) receive a charge level of each battery 81, 176 from each respective battery management system 83, 178 and subsequently determine whether the total charge level of battery system 80, 175 is less than the predetermined charge threshold. In other examples, one battery management system 83, 178 collects the charge level of each battery 81, 176 and sends the charge levels to those controller(s), which subsequently determines whether the total charge level is less than the predetermined charge threshold. In other examples, battery management system 83, 178 determines whether the total charge level is less than the predetermined charge threshold based on collected charge levels and sends the determination to those controller(s). In response to those controller(s) determining that the current charge level is less than the predetermined charge threshold, the method proceeds to block 530. Otherwise, in response to those controller(s) determining that the current charge level is greater than or equal to the predetermined charge threshold, the method proceeds to block 540.

At block 530, one or more controller(s) (e.g., autonomous controller 106; vehicle controller 51, 107; etc.) sends signals to drive controller(s) 52, 120 to autonomously drive utility vehicle 90, 190 to return to charging station 1005 to recharge and/or swap out one or more batteries 81, 176 of utility vehicle 90, 190. In some examples, those controller(s) 51, 107 send signals to blade controller(s) 53 or deck controllers 186 to stop mowing blade(s) 67, 198a from mowing prior to autonomously redirecting utility vehicle 90, 190 to charging station 1005. The method of operation ends for the current mow session upon completing block 530.

At block 540, one or more controllers (e.g., vehicle controller 51, 107) determine whether a safety fault has been detected. Example safety faults include overheating and/or short circuiting of battery 81, 176 detected by battery management system 83, 178. That is, in some examples, those controller(s) receive notification of a safety fault from battery management system 83, 178. Other example safety faults include an ambient temperature that exceeds a predefined temperature threshold, detection of slippage, detection of water, motor overheating, etc. Example non-safety faults include an inoperable and/or non-communicative battery management system 83, 178 and excessive power consumption (e.g., resulting from a flat tire, dull mower blade(s) 67, 198a, a short circuit, etc.). In response to those controller(s) determining that a safety fault has been detected, the method proceeds to block 550. Otherwise, in response to those controller(s) determining that a safety fault has not been detected, the method proceeds to block 560.

At block 550, one or more controllers (e.g., autonomous controller 106; vehicle controller 51, 107; etc.) send signals to drive controller(s) 52, 120 to identify and autonomously drive utility vehicle 90, 190 to a safe area, such as a parking lot and/or a secluded area far away from structures and trees. Additionally or alternatively, the safe area may include a garage and/or a loading truck. In some examples, the safe area is preselected. In other examples, the safe area is determined by those controller(s) based on data collected by cameras 111, sensors 60, 112; GNSS receiver(s) 40, 113; etc. and/or wireless communication with remote devices such as remote server 1055, nearby utility vehicles 90, 190, and/or nearby mobile devices. Additionally, in some examples, those controller(s) may identify that a person is nearby based on data collected from camera(s) 71, 111 and subsequently send a signal to transmit a signal to the person requesting assistance. Subroutine 500 is completed upon utility vehicle 90, 190 autonomously traveling to the safe area. The method of operation ends for the current mow session upon completing block 550.

At block 560, one or more controllers (e.g., autonomous controller 106; vehicle controller 51, 107; etc.) sends signal to drive controller(s) 52, 120 to autonomously drive utility vehicle 90, 190 to a service garage for assessment and servicing. The method of operation ends for the current mow session upon completing block 560.

Returning to block 510, the method of operation proceeds to subroutine 600 or subroutine 700 in response to one or more controllers (e.g., vehicle controller 51, 107) determining that no fault or alarm is detected. More specifically, the method of operation proceeds to subroutine 600 if, as depicted in FIGS. 1-2, utility vehicle 90, 190 includes camera(s) 71, 111. If, in other examples, utility vehicle does not include camera(s) 71, 111 for autonomous navigation purposes, the method of operation proceeds to subroutine 700.

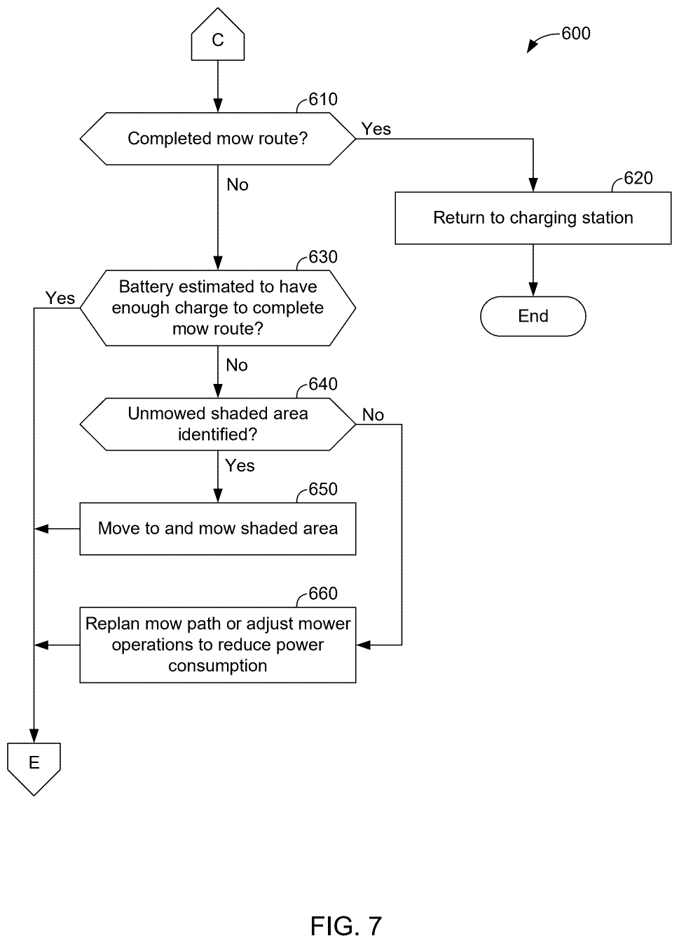

Turning to FIG. 7, subroutine 600 is performed by utility vehicle 90, 190 with camera(s) 71, 111 to potentially adjust a mow route or other utility functions in order to conserve a charge capacity of one or more batteries 81, 176. Initially, at block 610, one or more controllers (e.g., path controller 105; autonomous controller 106; vehicle controller 51, 107; etc.) determine whether utility vehicle 90, 190 has completed the mow route. In response to those controller(s) determining that the mow route has been completed, the method proceeds to block 620. Otherwise, in response to those controller(s) determining that the mow route has not been completed, the method proceeds to block 630.

At block 620, one or more controllers (e.g., autonomous controller 106; vehicle controller 51, 107; etc.) autonomously direct utility vehicle 90, 190 to charging station 1005, for example, by sending corresponding control signals to drive controller(s) 56, 120. The method of operation ends for the current mow session upon completing block 620.

At block 630, one or more controllers (e.g., vehicle controller 51, 107) determine whether one or more batteries 81, 176 are predicted to have enough charge to complete the planned mow path. For example, those controller(s) make the determination by comparing the current state-of-charge of one or more batteries 81, 176 to the expected or predicted state-of-charge upon completion of the planned mow path. The expected or predicted state-of-charge may be determined based on geographic data of the mow area. In some examples, the geographic data is collected by GNSS receiver 40, 113. Those controller(s) collect the current state-of-charge of one or more batteries 81, 176 from one or more battery management system(s) 83, 178 or determine the current state-of-charge based on data received from battery management system(s) 83, 178. Those controller(s) determine the expected state-of-charge upon mow completion based on map data of the planned mow route and historical and/or current power consumption data of utility vehicle 90, 190. In response to those controller(s) predicting that one or more batteries 81, 176 have enough charge to complete the planned mow path, subroutine 600 ends and the method of operation proceeds to subroutine 800. Otherwise, in response to those controller(s) predicting that one or more batteries 81, 176 do not have enough charge to complete the planned mow path, the method proceeds to block 640.

At block 640, one or more controllers (e.g., autonomous controller 106; vehicle controller 51, 107; etc.) determine whether there is any unmowed shaded section along the mow path. In response to those controller(s) determining that there is not any unmowed shaded section, the method proceeds to block 650 at which those controller(s) autonomously direct utility vehicle 90, 190 to the identified shaded section, for example, by sending corresponding control signals to drive controller(s) 56, 120.

That is, one or more controllers (e.g., path controller 105; autonomous controller 106; vehicle controller 51, 107; etc.) maintain an operating temperature of one or more batteries 81, 176 of battery system 80, 175 and/or other vehicle components by moving utility vehicle 90, 190 to a low power-consumption area, such as a shaded area, when ambient air temperature and/or operating temperature(s) of one or more batteries 81, 176 is above a predetermined temperature threshold. Those controller(s) may identify a shaded area based on images and/or video captured by camera(s) 71, 111, light sensor(s), location data, ambient temperature, and/or a battery temperature. Additionally or alternatively, those controller(s) may identify a shaded area by identifying locations at which a relatively small amount of power was consumed when the ambient temperature was known to be relatively high. Further, in some examples, weather prognostication data is collected from a remove device (e.g., through the Internet) via the wireless communication module 45, 115 to facilitate identification of temperature and/or grass-wetness levels.

In response to determining at block 640 that there is not any unmowed shaded section, the method proceeds to block 660 at which one or more controllers (e.g., path controller 105; vehicle controller 51, 107; etc.) replan the mow path to reduce power consumption. Additionally or alternatively, those controller(s) adjust one or more operations of utility vehicle 190 to reduce power consumption.

That is, one or more controllers (e.g., path controller 105; vehicle controller 51, 107; etc.) estimate the time and energy to complete a mow task and compare the estimated energy to the capacity of one or more batteries 81, 176. If the mow area is larger than the battery capacity will allow, one or more controllers (e.g., path controller 105; autonomous controller 106; vehicle controller 51, 107; etc.) adjust the mow route and/or other vehicle operations to reduce the rate of power consumption.

In some examples, one or more controllers (e.g., path controller 105; vehicle controller 51, 107; etc.) replan the mow route such that utility vehicle 90, 190 moves toward charging station 1005 as one or more batteries 81, 176 approach a state-of-charge of 0% to reduce the risk of running out of battery power while utility vehicle 90, 190 is far away from charging station 1005. For example, those controller(s) are configured to reroute utility vehicle 90, 190 to charging station 1005 when the state-of-charge becomes less than a predefined threshold (e.g., 5%) and/or upon determining that the state-of-charge will soon become less than what is needed to return to charging station 1005.

In some examples, one or more vehicles (e.g., autonomous controller 106; vehicle controller 51, 107; etc.) reduce a travel speed, increase a travel speed to complete the mow session more quickly, and/or reduce acceleration and deceleration. In some examples, one or more controllers (e.g., vehicle controller 51, 107) reduce the amount of grass cut per pass and/or cut blade power if traversing previously cut grass. Additionally or alternatively, if mowing blade(s) 67, 198a are variable-pitch blades, one or more controllers (e.g., vehicle controller 51, 107) may switch the direction of the blade spin to a direction associated with an efficiency mode.

Further, in some examples, a user is made aware of the current battery capacity and expected mow time, for example, via user interface module 104 and/or a mobile device communicatively coupled to wireless communication module 45, 115. In such examples, the user may select operating conditions for utility vehicle 90, 190 that reduces power consumption in a manner that enables utility vehicle 90, 190 to mow the mow area. For example, user interface module 104 and/or an app of a connected mobile device enables the user to select at least one of the following to reduce power consumption: reduce a travel speed, reduce a portion of mow area 1000 to be mowed, reduce a blade speed, or reduce a depth of cut. Additionally or alternatively, user interface module 104 and/or an app of a connected mobile device enables the user to select between (1) a fast-and-partial mow and (2) a slow-and-complete mow to reduce power consumption. With the fast-and-partial mow, one or more controllers (e.g., vehicle controller 51, 107) is configured to send control signals to increase the travel speed and reduce the portion of mow area 1000 to be mowed before returning to charging station 1005. With the slow-and-complete mow, those controller(s) are configured to reduce the travel speed, reduce the blade speed, and/or reduce the depth of cut to enable utility vehicle 90, 190 to complete its mow path before returning charging station 1005.

Upon completion of block 650 or block 660, subroutine 600 ends and the method of operation proceeds to subroutine 800.

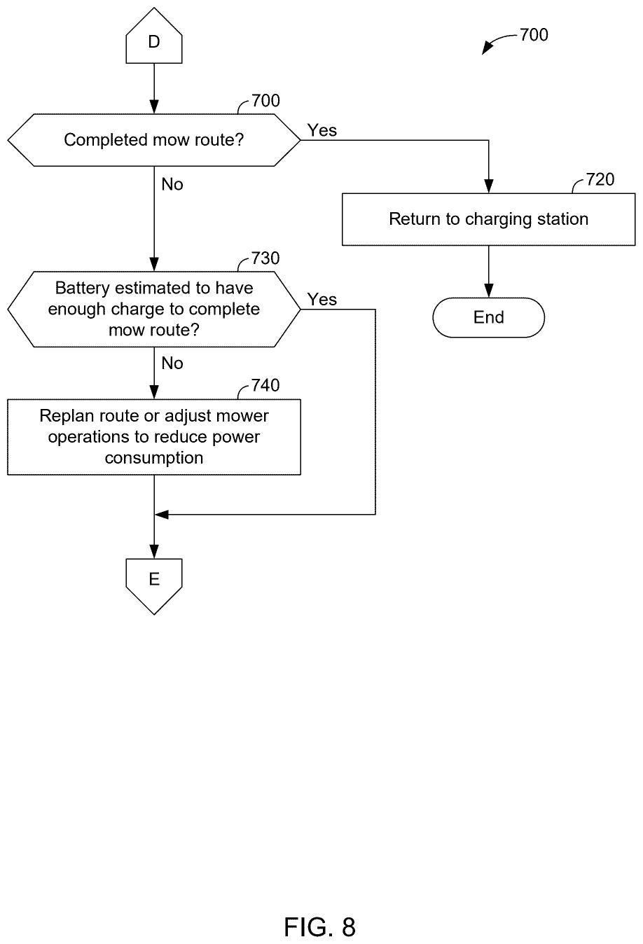

FIG. 8 depicts subroutine 700 that is performed by utility vehicle 90, 190 without camera(s) 71, 111 to potentially adjust a mow route or other utility functions in order to conserve a charge capacity of one or more batteries 81, 176.

Initially, at block 710, one or more controllers (e.g., path controller 105; autonomous controller 106; vehicle controller 51, 107; etc.) determine whether utility vehicle 90, 190 has completed the mow route. In response to those controller(s) determining that the mow route has been completed, the method proceeds to block 720. Otherwise, in response to those controller(s) determining that the mow route has not been completed, the method proceeds to block 730.

At block 730, one or more controllers (e.g., autonomous controller 106; vehicle controller 51, 107; etc.) autonomously direct utility vehicle 90, 190 to charging station 1005, for example, by sending corresponding control signals to drive controller(s) 56, 120. The method of operation ends for the current mow session upon completing block 720.

At block 730, one or more controllers (e.g., vehicle controller 51, 107) determine whether one or more batteries 81, 176 are predicted to have enough charge to complete the planned mow path. In response to those controller(s) predicting that batteries 176 have enough charge to complete the planned mow path, subroutine 700 ends and the method of operation proceeds to subroutine 800. Otherwise, in response to those controller(s) predicting that one or more batteries 81, 176 do not have enough charge to complete the planned mow path, the method proceeds to block 740.

At block 740, one or more controllers (e.g., path controller 105; vehicle controller 51, 107; etc.) replans the mow path to reduce power consumption, for example, as disclosed above with respect to block 660. Additionally or alternatively, one or more controllers (e.g., vehicle controller 51, 107) adjust one or more operations of utility vehicle 90, 190 to reduce power consumption, for example, as disclosed above with respect to block 660. Upon completing block 730 and/or block 740, the method of operation proceeds to subroutine 800.

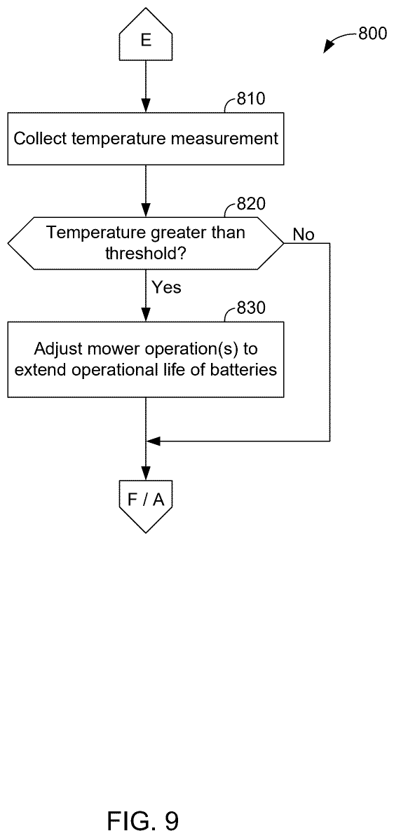

Turning to FIG. 9, subroutine 800 is performed by utility vehicle 90, 190 to potentially further conserve a charge capacity of one or more batteries 81, 176 and/or conserve an operating life of one or more batteries 81, 176. Initially, at block 810, one or more controllers (e.g., vehicle controller 51, 107) collect one or more temperature measurements. In some examples, those controller(s) monitor an ambient air temperature of a surrounding environment and collect the temperature measurement via an onboard thermometer or remotely via wireless communication module 45, 115. Additionally or alternatively, those controller(s) monitor operating temperature(s) of one or more batteries 81, 176 and collect the temperature measurements from battery management system(s) 83, 178. In other examples, those controller(s) may monitor operating temperatures of other vehicles components, such as motors.

At block 820, one or more controllers (e.g., vehicle controller 51, 107) determine whether the measured temperature is greater than a predetermined temperature threshold. In response to those controller(s) determining that the measured temperature is less than or equal to the predetermined temperature threshold, subroutine 800 ends. Otherwise, in response to those controller(s) determining that the measured temperature is greater than the predetermined temperature threshold, one or more controllers of utility vehicle 90, 190 adjust performance of an operation to extend the operating life of one or more batteries 81, 176, for example, by reducing a rate of unrecoverable capacity loss of cells 177. For example, one or more controllers (e.g., path controller 105; autonomous controller 106; vehicle controller 51, 107; etc.) may adjust one or more operations of utility vehicle 90, 190 to extend the operating life of one or more batteries 81, 176. Example adjustments that extend a battery life includes reducing a vehicle speed, a blade speed, a depth of cut. Example adjustments also include readjusting the mow path to ensure utility vehicle 90, 190 returns to charging station 1005 before batteries reach a state-of-charge of 0%. Another example adjustment to extend the operating life of one or more batteries 81, 176 includes only cutting grass via mowing blade(s) 67, 198a when the state-of-charge of one or more batteries 81, 176 is within a predefined range (e.g., between 20% and 80%).

Upon completing subroutine 800, the method of operation proceeds to subroutine 900 or returns to subroutine 400. More specifically, the method of operation proceeds to subroutine 900 if utility vehicle 90, 190 is capable of applying fertilizer and/or water treatment to a mow area. If utility vehicle 90, 190 does not fertilizer and/or water treatment capabilities, the method of operation returns to subroutine 400 upon completing subroutine 800.

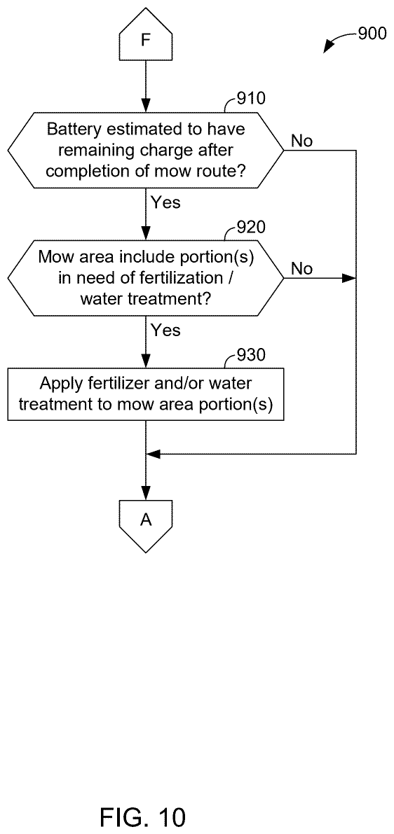

Turning to FIG. 10, subroutine 900 is performed to potentially apply fertilizer and/or water treatment to a mow area. Initially, at block 910, one or more controllers (e.g., vehicle controller 51, 107) determine whether one or more batteries 81, 176 are predicted to have at least a predetermined threshold of remaining charge upon completing the planned mow path. For example, those controller(s) make the determination by comparing the current state-of-charge of one or more batteries 81, 176 to the expected state-of-charge upon completion of the planned mow path. Those controller(s) collect the current state-of-charge of one or more batteries 81, 176 from one or more battery management system(s) 83, 178 or determine the current state-of-charge based on data received from battery management system(s) 83, 178. Those controller(s) determine the expected state-of-charge upon mow completion based on map data of the planned mow route and historical and/or current power consumption data.

In response to those controller(s) determining that there will be less than the predetermined threshold of remaining charge at time of route completion, subroutine 900 is completed and the method of operation returns to subroutine 400. Otherwise, in response to those controller(s) determining that there will be at least the predetermined threshold of remaining charge at time of route completion, the method proceeds to block 920 at which those controller(s) determine whether the mow area includes any portion in need of fertilization and/or water treatment. For example, those controller(s) may identify areas with thin grass in need of fertilization and/or water application by identifying locations where collected data indicates power consumption was less than expected. In response to those controller(s) determining that fertilization and/or water treatment is not needed, subroutine 900 is completed and the method of operation returns to subroutine 400. Otherwise in response to those controller(s) determining that fertilization and/or water treatment is needed, the method proceeds to block 930 at which those controller(s) generate a treatment plan for utility vehicle (e.g., utility vehicle 90, 190) to apply fertilizer and/or water based on the treatment plan. Upon completing block 930, subroutine 900 ends and the method of operation returns to subroutine 400.

That is, for utility vehicles 90, 190 with hardware for applying fertilizer and/or water treatment, those controller(s) are configured to use collected power consumption data and route planning data to identify locations of thick grass and/or thin grass and, in turn, generate fertilization and/or water application plans for the mow area. In some examples, those controller(s) are configured to adjust a fertilization spread rate for different locations based on the collected data associated with those locations.

In other examples, one or more controllers (e.g., vehicle controller 51, 107) determine whether the mow area includes any portion in need of fertilization and/or water treatment regardless of the remaining charge of batteries 81, 176 of utility vehicle 90, 190 mowing the mow area. For example, those controller(s) determine, while mowing mow area, whether there is any portion in need of fertilization and/or water treatment. In some examples, wireless communication module transmits water/fertilization data to remote server 1055 and/or a mobile device of the user via wireless communication module 45, 115. The vehicle controller(s), remote server 1055, and/or the mobile device may generate a water and/or fertilization map of the mow area based on the collected data. In some such examples, an app of the mobile device may display water and/or fertilization map to the user. The user may then determine whether to send another utility vehicle capable of watering and/or fertilizing to portions of the map in need of watering and/or fertilizing.

Exemplary embodiments in accordance with the teachings herein are disclosed below.
Embodiment 1. An electric utility vehicle with autonomous controls includes driven wheels, at least one electric motor configured to drive the driven wheels, at least one mowing blade, at least one blade motor configured to drive the at least one mowing blade, at least one battery configured to power the at least one electric motor and the at least one blade motor, at least one battery management system configured to monitor the at least one battery, at least one global navigation satellite system receiver, and one or more controllers communicatively connected to memory. The one or more controllers are configured to identify whether map data for a mow area is stored in the memory and perform a sparse-mow routine in response to identifying that no map data corresponding to the mow area has been stored in the memory. To perform the sparse-mow routine, the one or more controllers are configured to autonomously steer the electric utility vehicle, via the at least one electric motor, to travel over a sample of each portion of the mow area; collect location data via the at least one global navigation satellite system receiver during the sparse-mow routine; and collect current discharge data via the at least one battery management system during the sparse-mow routine. The one or more controllers are configured to generate an energy-consumption map for the mow area by correlating the current discharge data collected during the sparse-mow routine with the location data collected during the sparse-mow routine and determine an efficient-mow path for subsequent mowing events of the mow area based on the energy-consumption map.
Embodiment 2. The electric utility vehicle of Embodiment 1, wherein the at least one electric motor comprises a pair of motors, wherein each motors of the pair of motors is configured to drive a separate one of the driven wheels.
Embodiment 3. The electric utility vehicle of Embodiments 1 or 2, wherein the one or more controllers are configured to determine the efficient-mow path further based on at least one of historical mow data; weather data, wetness data, or cut length data.
Embodiment 4. The electric utility vehicle of any of Embodiments 1-3, wherein the one or more controllers are further configured to autonomously steer the electric utility vehicle to stay within boundary lines of the mow area defined by at least one of boundary wire or geofencing.
Embodiment 5. The electric utility vehicle of any of Embodiments 1-4, wherein, to perform the sparse-mow routine, the one or more controllers are further configured to steer the electric utility vehicle to leave unmowed sections between passes in the mow area. The unmowed sections have a width of a cut width of the electric utility vehicle.
Embodiment 6. The electric utility vehicle of any of Embodiments 1-5, wherein, to perform the sparse-mow routine, the one or more controllers are further configured to autonomously steer the electric utility vehicle along a Hamiltonian path or cycle. The one or more controllers are further configured to generate the Hamiltonian path or cycle based on predetermined boundaries of the mow area.
Embodiment 7. The electric utility vehicle of any of Embodiments 1-5, wherein, to perform the sparse-mow routine, the one or more controllers are further configured to autonomously steer the electric utility vehicle based on a set of preprogrammed rules that are repeated until the electric utility vehicle has covered the mow area during the sparse-mow routine.
Embodiment 8. The electric utility vehicle of Embodiments 7, wherein, based on the set of preprogrammed rules, the one or more controllers are configured to steer the electric utility vehicle in a direction farthest away from one or more portions of the mow area that have already been examined during the sparse-mow routine.
Embodiment 9. The electric utility vehicle of Embodiment 7, wherein, based on the set of preprogrammed rules, the one or more controllers are configured to steer the electric utility vehicle in a first direction until a boundary of the mow area is detected, subsequently turn the electric utility vehicle to travel in a second direction until the boundary is detected, subsequently turn the electric utility vehicle to travel in a third direction until the boundary is detected, and subsequently turn the electric utility vehicle to travel in a fourth direction until the boundary is detected.
Embodiment 10. The electric utility vehicle of any of Embodiments 1-9, further comprising at least one of a camera, a lidar sensor, a radar sensor, or an ultrasonic sensor. The one or more controllers are configured to determine the efficient-mow path based on data collected by the at least one of the camera, the lidar sensor, the radar sensor, and the ultrasonic sensor.
Embodiment 11. The electric utility vehicle of any of Embodiments 1-10, wherein the one or more controllers are further configured to detect a low charge of the at least one battery, via the at least one battery management system, while the electric utility vehicle is travelling along the efficient-mow path to mow the mow area.
Embodiment 12. The electric utility vehicle of Embodiment 11, wherein the one or more controllers are further configured to adjust at least one of a mow path or performance of the at least one mowing blade in response to detecting the low charge of the at least one battery to conserve energy while continuing to mow the mow area.
Embodiment 13. The electric utility vehicle of Embodiment 12, wherein the one or more controllers are configured to adjust the mow path to return the electric utility vehicle to a charging station.
Embodiment 14. The electric utility vehicle of any of Embodiments 1-13, wherein the one or more controllers are configured to redirect the electric utility vehicle to a preselected safe location in response to detecting a safety fault.
Embodiment 15. The electric utility vehicle of any of Embodiments 1-14, wherein the one or more controllers are configured to redirect the electric utility vehicle from the efficient-mow path to a shaded area location in response to detecting that a measured temperature exceeds a predetermined temperature threshold.
Embodiment 16. An electric utility vehicle with autonomous controls includes driven wheels, at least one electric motor configured to drive the driven wheels, at least one mowing blade, at least one blade motor configured to drive the at least one mowing blade, at least one battery configured to power the at least one electric motor and the at least one blade motor, at least one battery management system configured to monitor the at least one battery, and one or more controllers communicatively connected to memory. The one or more controllers are configured to autonomously steer the electric utility vehicle, via the at least one electric motor, to travel along a mow path in a mow area; activate the at least one mowing blade while traveling along the mow path to mow the mow area; detect a current charge level of the at least one battery via the at least one battery management system; calculate a predicted charge level required to complete the mow path based on geographic data of the mow area; compare the current charge level to the predicted charge level; and in response to determining that current charge level is less than the predicted charge level, adjust at least one of the mow path or operation of the at least one mowing blade to conserve energy while continuing to mow the mow area.
Embodiment 17. The electric utility vehicle of Embodiment 16, wherein the at least one electric motor comprises a pair of motors. Each motor of the pair of motors is configured to drive a separate one of the driven wheels.
Embodiment 18. The electric utility vehicle of Embodiment 16 or 17, further comprising at least one global navigation satellite system receiver configured to collect the geographic data of the mow area. The geographic data is configured to be stored in the memory.
Embodiment 19. The electric utility vehicle of any of Embodiments 16-18, wherein the one or more controllers are further configured to autonomously steer the electric utility vehicle to stay within boundary lines of the mow area defined by at least one of boundary wire or geofencing.
Embodiment 20. The electric utility vehicle of any of Embodiments 16-19, further comprising at least one of a camera, a lidar sensor, a radar sensor, or an ultrasonic sensor. The one or more controllers are further configured to steer the electric utility vehicle along the mow path based on data collected by the at least one of the camera, the lidar sensor, the radar sensor, or the ultrasonic sensor.
Embodiment 21. The electric utility vehicle of any of Embodiments 16-20, wherein, prior to autonomously steering the electric utility vehicle to travel along the mow path, the one or more controllers are further configured to perform a sparse-mow routine to collect sparse-mow data associated with the mow area and generate the mow path based on the sparse-mow data collected during the sparse-mow routine.
Embodiment 22. The electric utility vehicle of any of Embodiments 16-21, wherein, to adjust the mow path, the one or more controllers are configured to redirect the electric utility vehicle to a charging station.
Embodiment 23. The electric utility vehicle of any of Embodiments 16-22, wherein, to adjust the mow path to conserve energy while continuing to mow the mow area, the one or more controllers are configured to redirect the electric utility vehicle to mow an unmowed shaded area of the mow area.
Embodiment 24. The electric utility vehicle of any of Embodiments 16-22, wherein, to conserve energy while continuing to mow the mow area, the one or more controllers are configured to reduce a travel speed of the electric utility vehicle, adjust the mow path to reduce a portion of the mow area to be mowed, reduce a blade speed of the one mowing blade, or reduce a depth of cut of the at least one mowing blade.
Embodiment 25. The electric utility vehicle of any of Embodiments 16-22, wherein, to conserve energy while continuing to mow the mow area, the one or more controllers are configured to perform a fast-and-partial mow by increasing a travel speed of the electric utility vehicle and adjusting the mow path to reduce a portion of the mow area to be mowed.
Embodiment 26. The electric utility vehicle of any of Embodiments 16-22, wherein, to conserve energy while continuing to mow the mow area, the one or more controllers are configured to perform a slow-and-complete mow by at least one of reducing a travel speed of the electric utility vehicle, reducing a blade speed of the at least one mowing blade, or reducing a depth of cut of the at least one mowing blade.
Embodiment 27. The electric utility vehicle of any of Embodiments 16-26, wherein the one or more controllers are further configured to adjust the mow path by redirecting the electric utility vehicle to a preselected safe location in response to detecting a safety fault.
Embodiment 28. The electric utility vehicle of any of Embodiments 16-27, wherein the one or more controllers are further configured to adjust the mow path by redirecting the electric utility vehicle to a garage in response to detecting a non-safety fault.
Embodiment 29. The electric utility vehicle of any of Embodiments 16-28, wherein the one or more controllers are further configured to redirect the electric utility vehicle to a shaded area location in response to detecting that a measure temperature exceeds a predetermined temperature threshold.
Embodiment 30. The electric utility vehicle of any of Embodiments 16-29, wherein the one or more controllers are further configured to generate a water/fertilization map of the mow area based on the geographic data and battery discharge data collected as the electric utility vehicle mowed the mow area.
Embodiment 31. A system is for autonomous mowing in a mow area. The system comprises a charging station and an electric utility vehicle. The electric utility vehicle comprises driven wheels, at least one electric motor configured to drive the driven wheels, at least one mowing blade, at least one blade motor configured to drive the at least one mowing blade, at least one battery configured to power the at least one electric motor and the at least one blade motor, at least one battery management system configured to monitor the at least one battery, and one or more controllers communicatively connected to memory. The one or more controllers are configured to autonomously steer the electric utility vehicle, via the at least one electric motor, to travel along a mow path in the mow area; activate the at least one mowing blade while traveling along the mow path to mow the mow area; detect a current charge level of the at least one battery via the at least one battery management system; calculate a predicted charge level required to complete the mow path based on geographic data of the mow area; compare the current charge level to the predicted charge level; and in response to determining that current charge level is less than the predicted charge level, adjust at least one of the mow path or operation of the at least one mowing blade to conserve energy while continuing to mow the mow area.

The electric utility vehicle of Embodiment 31 may further include feature(s) of the electric utility vehicle of any of Embodiments 17-30 disclosed above.
Embodiment 32. A system is for autonomous mowing in a mow area. The system comprises a fleet of electric utility vehicles configured to mow the mow area. Each electric utility vehicle of the fleet is configured to mow a respective portion of the mow area. Each electric utility vehicle includes driven wheels, at least one electric motor configured to drive the driven wheels, at least one mowing blade, at least one blade motor configured to drive the at least one mowing blade, at least one battery configured to power the at least one electric motor and the at least one blade motor, a wireless communication module configured to communicate with other electric utility vehicles of the fleet, at least one battery management system configured to monitor the at least one battery, and one or more controllers communicatively connected to memory. The one or more controllers are configured to autonomously steer the electric utility vehicle, via the at least one electric motor, to travel along a mow path in the respective portion of the mow area; activate the at least one mowing blade while traveling along the mow path to mow the respective portion of the mow area; detect a current charge level of the at least one battery via the at least one battery management system; calculate a predicted charge level required to complete the mow path based on geographic data of the respective portion of the mow area; determine, based on a comparison of the current charge level to the predicted charge level, whether the electric utility vehicle is able to complete the mow path; repartition the mow area in response to determining that the mow path is unable to be completed; adjust the mow path for a respective repartitioned portion of the mow area; and transmit a signal, via the wireless communication module, instructing the other electric utility vehicles of the fleet of respective repartitioned portions of the mow area.

Each electric utility vehicle of the system of Embodiment 32 may further include feature(s) of the electric utility vehicle of any of Embodiments 17-30 disclosed above.
Embodiment 33. A system is for autonomous mowing in a mow area. The system comprises a fleet of electric utility vehicles configured to mow the mow area. Each electric utility vehicle of the fleet is configured to mow a respective portion of the mow area. Each electric utility vehicle includes driven wheels, at least one electric motor configured to drive the driven wheels, at least one mowing blade, at least one blade motor configured to drive the at least one mowing blade, at least one battery configured to power the at least one electric motor and the at least one blade motor, a wireless communication module configured to communicate with other electric utility vehicles of the fleet, at least one battery management system configured to monitor the at least one battery, and one or more controllers communicatively connected to memory. The one or more controllers are configured to autonomously steer the electric utility vehicle, via the at least one electric motor, to travel along a mow path in the respective portion of the mow area; activate the at least one mowing blade while traveling along the mow path to mow the respective portion of the mow area; detect a current charge level of the at least one battery via the at least one battery management system; calculate a predicted charge level required to complete the mow path based on geographic data of the respective portion of the mow area; determine, based on a comparison of the current charge level to the predicted charge level, whether the electric utility vehicle is able to complete the mow path; transmit a signal, via the wireless communication module, instructing one or more of the other electric utility vehicles of the fleet that the mow path is unable to be completed; receive, via the wireless communication module, a repartition of the respective portion of the mow area from one of the other electric utility vehicles; and adjust the mow path for the respective portion of the mow area based on the repartition.

Each electric utility vehicle of the system of Embodiment 33 may further include feature(s) of the electric utility vehicle of any of Embodiments 17-30 disclosed above.
Embodiment 34. A system is for autonomous mowing in a mow area. The system comprises a remote server configured to partition and repartition the mow area into portions and a fleet of electric utility vehicles configured to mow the mow area. Each electric utility vehicle of the fleet is configured to mow a respective portion of the mow area. Each electric utility vehicle includes driven wheels, at least one electric motor configured to drive the driven wheels, at least one mowing blade, at least one blade motor configured to drive the at least one mowing blade, at least one battery configured to power the at least one electric motor and the at least one blade motor, a wireless communication module configured to communicate with the remote server, at least one battery management system configured to monitor the at least one battery, and one or more controllers communicatively connected to memory. The one or more controllers are configured to autonomously steer the electric utility vehicle, via the at least one electric motor, to travel along a mow path in the respective portion of the mow area; activate the at least one mowing blade while traveling along the mow path to mow the respective portion of the mow area; detect a current charge level of the at least one battery via the at least one battery management system; calculate a predicted charge level required to complete the mow path based on geographic data of the respective portion of the mow area; determine, based on a comparison of the current charge level to the predicted charge level, whether the electric utility vehicle is able to complete the mow path; transmit a signal, via the wireless communication module, instructing the remote server that the mow path is unable to be completed; receive, via the wireless communication module, a repartition of the respective portion of the mow area from the remote server; and adjust the mow path for the respective portion of the mow area based on the repartition.

Each electric utility vehicle of the system of Embodiment 34 may further include feature(s) of the electric utility vehicle of any of Embodiments 17-30 disclosed above.
Embodiment 35. A control system is for an electric utility vehicle having driven wheels, at least one electric motor configured to drive the driven wheels, at least one mowing blade, at least one blade motor configured to drive the at least one mowing blade, and at least one battery configured to power the at least one electric motor and the at least one blade motor. The control system comprises at least one battery management system configured to monitor the at least one battery, at least one global navigation satellite system receiver, and one or more controllers communicatively connected to memory. The one or more controllers are configured to identify whether map data for a mow area is stored in the memory and perform a sparse-mow routine in response to identifying that no map data corresponding to the mow area has been stored in the memory. To perform the sparse-mow routine, the one or more controllers are configured to autonomously steer the electric utility vehicle, via the at least one electric motor, to travel over a sample of each portion of the mow area, collect location data via the at least one global navigation satellite system receiver during the sparse-mow routine, and collect current discharge data via the at least one battery management system during the sparse-mow routine. The one or more controllers are configured to generate an energy-consumption map for the mow area by correlating the current discharge data collected during the sparse-mow routine with the location data collected during the sparse-mow routine and determine an efficient-mow path for subsequent mowing events of the mow area based on the energy-consumption map.

The control system of Embodiment 35 may further include feature(s) of the electric utility vehicle of any of Embodiments 3-15 disclosed above.
Embodiment 36. A control system is for an electric utility vehicle having driven wheels, at least one electric motor configured to drive the driven wheels, at least one mowing blade, at least one blade motor configured to drive the at least one mowing blade, and at least one battery configured to power the at least one electric motor and the at least one blade motor. The control system comprises at least one battery management system configured to monitor the at least one battery and one or more controllers communicatively connected to memory. The one or more controllers are configured to autonomously steer the electric utility vehicle, via the at least one electric motor, to travel along a mow path in a mow area; activate the at least one mowing blade while traveling along the mow path to mow the mow area; detect a current charge level of the at least one battery via the at least one battery management system; calculate a predicted charge level required to complete the mow path based on geographic data of the mow area; compare the current charge level to the predicted charge level; and in response to determining that current charge level is less than the predicted charge level, adjust at least one of the mow path or operation of the at least one mowing blade to conserve energy while continuing to mow the mow area.

The control system of Embodiment 36 may further include feature(s) of the electric utility vehicle of any of Embodiments 18-30 disclosed above.

1. An electric utility vehicle with autonomous controls, the electric utility vehicle comprising:
driven wheels;
at least one electric motor configured to drive the driven wheels;
at least one mowing blade;
at least one blade motor configured to drive the at least one mowing blade;
at least one battery configured to power the at least one electric motor and the at least one blade motor;
at least one battery management system configured to monitor the at least one battery;
at least one global navigation satellite system receiver; and
one or more controllers communicatively connected to memory, wherein the one or more controllers are configured to:
identify whether map data for a mow area within predetermined boundary lines is stored in the memory;
perform a sparse-mow routine in response to identifying that no map data corresponding to the mow area has been stored in the memory, wherein, to perform the sparse-mow routine, the one or more controllers are configured to:
autonomously steer the electric utility vehicle, via the at least one electric motor, to travel over a sample of the mow area leaving unmowed sections in the mow area,
collect location data via the at least one global navigation satellite system receiver during the sparse-mow routine; and
collect current discharge data via the at least one battery management system during the sparse-mow routine;
generate an energy-consumption map for the mow area by correlating the current discharge data collected during the sparse-mow routine with the location data collected during the sparse-mow routine; and
determine an efficient-mow path for subsequent mowing events of the mow area based on the energy-consumption map.

2. The electric utility vehicle of claim 1, wherein the at least one electric motor comprises a pair of motors, wherein each motors of the pair of motors is configured to drive a separate one of the driven wheels.

3. The electric utility vehicle of claim 1, wherein the one or more controllers are configured to determine the efficient-mow path further based on at least one of historical mow data; weather data, wetness data, or cut length data.

4. The electric utility vehicle of claim 1, wherein the one or more controllers are further configured to autonomously steer the electric utility vehicle to stay within the predetermined boundary lines defined by at least one of boundary wire or geofencing.

5. The electric utility vehicle of claim 1, wherein the unmowed sections of the sparse-mow routine have a width that equals a cut width of the electric utility vehicle.

6. The electric utility vehicle of claim 1, wherein, to perform the sparse-mow routine, the one or more controllers are further configured to autonomously steer the electric utility vehicle along a Hamiltonian path or cycle, wherein the one or more controllers are further configured to generate the Hamiltonian path or cycle based on the predetermined boundaries lines.

7. The electric utility vehicle of claim 1, wherein, to perform the sparse-mow routine, the one or more controllers are further configured to autonomously steer the electric utility vehicle based on a set of preprogrammed rules that are repeated until the electric utility vehicle has covered the mow area during the sparse-mow routine.

8. The electric utility vehicle of claim 7, wherein, based on the set of preprogrammed rules, the one or more controllers are configured to steer the electric utility vehicle in a direction farthest away from one or more portions of the mow area that have already been examined during the sparse-mow routine.

9. The electric utility vehicle of claim 7, wherein, based on the set of preprogrammed rules, the one or more controllers are configured to:
steer the electric utility vehicle in a first direction until one of the predetermined boundary lines or an object is detected;
subsequently turn the electric utility vehicle to travel in a second direction until one of the predetermined boundary lines or an object is detected;
subsequently turn the electric utility vehicle to travel in a third direction until one of the predetermined boundary lines or an object is detected; and
subsequently turn the electric utility vehicle to travel in a fourth direction until one of the predetermined boundary lines or an object is detected.

10. The electric utility vehicle of claim 1, further comprising at least one of a camera, a lidar sensor, a radar sensor, or an ultrasonic sensor, and wherein the one or more controllers are configured to determine the efficient-mow path based on data collected by the at least one of the camera, the lidar sensor, the radar sensor, and the ultrasonic sensor.

11. (canceled)

12. (canceled)

13. (canceled)

14. (canceled)

15. (canceled)

16. An electric utility vehicle with autonomous controls, the electric utility vehicle comprising:
driven wheels;
at least one electric motor configured to drive the driven wheels;
at least one mowing blade;
at least one blade motor configured to drive the at least one mowing blade;
at least one battery configured to power the at least one electric motor and the at least one blade motor;
at least one battery management system configured to monitor the at least one battery;
at least one global navigation satellite system receiver; and
one or more controllers communicatively connected to memory, wherein the one or more controllers are configured to:
identify whether map data for a mow area within predetermined boundary lines is stored in the memory;
perform a sparse-mow routine in response to identifying that no map data corresponding to the mow area has been stored in the memory, wherein, to perform the sparse-mow routine, the one or more controllers are configured to:
autonomously steer the electric utility vehicle, via the at least one electric motor, to travel over a sample of the mow area;
collect location data via the at least one global navigation satellite system receiver during the sparse-mow routine; and
collect current discharge data via the at least one battery management system during the sparse-mow routine;
generate an energy-consumption map for the mow area by correlating the current discharge data collected during the sparse-mow routine with the location data collected during the sparse-mow routine;
determine an efficient-mow path for subsequent mowing events of the mow area based on the energy-consumption map; and
redirect the electric utility vehicle from the efficient-mow path to a shaded area location in response to detecting that a measured temperature exceeds a predetermined temperature threshold.

17. The electric utility vehicle of claim 16, wherein the at least one electric motor comprises a pair of motors, wherein each motors of the pair of motors is configured to drive a separate one of the driven wheels.

18. The electric utility vehicle of claim 16, further comprising at least one of a camera, a lidar sensor, a radar sensor, or an ultrasonic sensor, and wherein the one or more controllers are configured to determine the efficient-mow path based on data collected by the at least one of the camera, the lidar sensor, the radar sensor, and the ultrasonic sensor.

19. An electric utility vehicle with autonomous controls, the electric utility vehicle comprising:
driven wheels;
at least one electric motor configured to drive the driven wheels;
at least one mowing blade;
at least one blade motor configured to drive the at least one mowing blade;
at least one battery configured to power the at least one electric motor and the at least one blade motor;
at least one battery management system configured to monitor the at least one battery;
at least one global navigation satellite system receiver; and
one or more controllers communicatively connected to memory, wherein the one or more controllers are configured to:
identify whether map data for a mow area within predetermined boundary lines is stored in the memory;
perform a sparse-mow routine in response to identifying that no map data corresponding to the mow area has been stored in the memory, wherein, to perform the sparse-mow routine, the one or more controllers are configured to:
autonomously steer the electric utility vehicle, via the at least one electric motor, to travel over a sample of the mow area;
collect location data via the at least one global navigation satellite system receiver during the sparse-mow routine; and
collect current discharge data via the at least one battery management system during the sparse-mow routine;
generate an energy-consumption map for the mow area by correlating the current discharge data collected during the sparse-mow routine with the location data collected during the sparse-mow routine; and
determine an efficient-mow path for subsequent mowing events of the mow area based on the energy-consumption map.

20. The electric utility vehicle of claim 19, wherein the at least one electric motor comprises a pair of motors, wherein each motors of the pair of motors is configured to drive a separate one of the driven wheels.

21. The electric utility vehicle of claim 19, further comprising at least one of a camera, a lidar sensor, a radar sensor, or an ultrasonic sensor, and wherein the one or more controllers are configured to determine the efficient-mow path based on data collected by the at least one of the camera, the lidar sensor, the radar sensor, and the ultrasonic sensor.

22. The electric utility vehicle of claim 19, wherein the one or more controllers are further configured to detect a low charge of the at least one battery, via the at least one battery management system, while the electric utility vehicle is travelling along the efficient-mow path to mow the mow area.

23. The electric utility vehicle of claim 20, wherein the one or more controllers are further configured to adjust at least one of a mow path or performance of the at least one mowing blade in response to detecting the low charge of the at least one battery to conserve energy while continuing to mow the mow area.

24. The electric utility vehicle of claim 23, wherein the one or more controllers are configured to adjust the mow path to return the electric utility vehicle to a charging station.

25. The electric utility vehicle of any of claims 19, wherein the one or more controllers are configured to redirect the electric utility vehicle to a preselected safe location in response to detecting a safety fault.
